(19) United States
(12) Patent Application Publication
(10) Pub. No.: US 2025/0178930 A1
(43) Pub. Date: Jun. 5, 2025

(54) COMPOSITE MEMBRANE FOR DESALINATION

(71) Applicant: KING FAHD UNIVERSITY OF PETROLEUM AND MINERALS, Dhahran (SA)

(72) Inventors: Ali Shaikh ASROF, Dhahran (SA); Zeeshan ARSHAD, Dhahran (SA); Nadeem BAIG, Dhahran (SA)

(73) Assignee: KING FAHD UNIVERSITY OF PETROLEUM AND MINERALS, Dhahran (SA)

(21) Appl. No.: 18/524,261

(22) Filed: Nov. 30, 2023

(51) Int. Cl. C02F 1/44; B01D 67/00; B01D 69/12; B01D 71/48; B01D 71/56; B01D 71/68

(52) U.S. Cl. CPC C02F 1/44; B01D 67/0006; B01D 69/1216; B01D 69/125; B01D 71/481; B01D 71/56; B01D 71/68; B01D 2323/219; B01D 2325/04; B01D 2325/20

(57) ABSTRACT

A composite membrane for desalination includes a polyethylene terephthalate (PET) nonwoven layer having a fibrous structure, and has an average thickness of about 30 to 200 micrometers (μm). A polysulfone (PS) layer having an average thickness of about 30 to 100 μm is disposed on a surface of the PET nonwoven layer. Further, a polyamide layer is disposed on a surface of the PS layer including reacted units of an acyl compound, a phenylenediamine monomer, and a poly-(DADMAC-co-DADA). The polyamide layer has a rough surface including a plurality of irregular-sized ridge-and-valley structures of polyamide. The poly-(DADMAC-co-DADA) has a formula (I), and n is a positive integer.

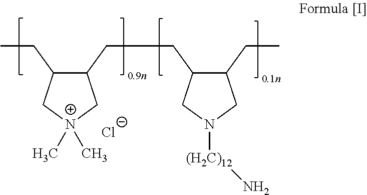

### STATEMENT REGARDING PRIOR DISCLOSURE BY THE INVENTORS

Aspects of this technology are described in Z. Arshad, N. Baig, and S. Ali “Synthesis of a novel next-generation positively charged polymer and its in-situ grafting into thin film composite membranes to enhance the performance for desalination” published in Process Safety and Environmental Protection, Volume 178, 34-45, which is incorporated herein by reference in its entirety.

### STATEMENT OF ACKNOWLEDGEMENT

This research was supported by the Deanship of Research Oversight & Coordination at King Fahd University of Petroleum & Minerals (KFUPM) under the project ER221001.

### BACKGROUND

### Technical Field

The present disclosure is directed to a filtration membrane, and particularly, to next-generation positively charged polymer thin film composite membranes for desalination.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Desalination plants provide fresh water from saline sources, serving needs in drinking water, as well as industrial and agricultural applications. In response to the substantial operational costs associated with desalination plants, the development of specialized membranes has emerged as a practical solution. Thin-film-composite (TFC) polyamide membranes are used in reverse osmosis (RO), in which the membranes allow the water to pass and comprehensively reject the salts. The performance of the TFC membranes for desalination mainly depends upon the active layer formed by the reaction of the m-phenylenediamine (MPD) and trimesoyl chloride (TMC) on the microporous support. The solute rejection and the solution permeance define the efficiencies of these membranes. For example, it has been observed that free carboxylic acid in the polyamide active layer results in the high permeation flux of the membrane. The conventional polyamide active layer has a limitation of fouling and a bottleneck of the trade-off of permeation and rejection. Thus, the anti-fouling and permeability/selectivity trade-off relationship has become the membrane technology focal point. The salt rejection and water permeability pervasive trade-off effect and fouling have become significant obstacles to enhancing the performance of the membranes and broadening their applications. Several materials, including MWNTs, surface-modifying macromolecules (SMMs), polyhedral oligomeric silsesquioxane nanoparticles, Zirconia nanofibers, HKUST-1, MoS₂ nanosheets have been incorporated to the membrane design, aiming to bolster the effectiveness of desalination processes.

Modified titanate nanotube and halloysite nanotube have been employed to enhance the permeation rates without significant change in rejection rates (See: Fallahnejad, Z., Bakeri, G., Ismail, A. F., 2022. Overcoming the tradeoff between the permeation and rejection of TFN nanofiltration membranes through embedding magnetic inner surface functionalized nanotubes. Process Safety and Environmental Protection 165, 815-840). Similarly, different loadings of the cellulose nanocrystals have been incorporated into the polyamide active layer of the thin-film nanocomposite reverse osmosis membranes to address the challenge of permeability/selectivity trade-off (See: Abedi, F., Emadzadeh, D., Dubé, M. A., Kruczek, B., 2022. Modifying cellulose nanocrystal dispersibility to address the permeability/selectivity trade-off of thin-film nanocomposite reverse osmosis membranes. Desalination 538, 115900). A nanoporous graphene membrane containing graphene particles with a diameter of 2 to 4 nanometers shows improved salt rejection (See: Zhang, Z., Li, S., Mi, B., Wang, J., Ding, J., 2020. Surface slip on rotating graphene membrane enables the temporal selectivity that breaks the permeability-selectivity trade-off. Sci Adv 6). It's worth noting that nanomaterials described above, when incorporated into the polyamide active layer, may agglomerate, or sometimes their size is half or more the active layer size as the polyamide active layer size in tens of nm, resulting in defects forming into the polyamide active layer. The leaching of nanomaterials may contribute to the operational defects if these materials are not rationally introduced into the polyamide active layer. A charged SMM was synthesized and incorporated into a cellulose acetate membrane that showed improved separation efficiency for personal care and pharmaceutical products (PCPPs) from water (Rana, D., Scheier, B., Narbaitz, R. M., Matsuura, T., Tabe, S., Jasim, S. Y., Khulbe, K. C., 2012. Comparison of cellulose acetate (CA) membrane and novel CA membranes containing surface modifying macromolecules to remove pharmaceutical and personal care product micropollutants from drinking water. J Memb Sci 409-410, 346-354). In another attempt to remove PCPPs and EDCs (endocrine-disrupting chemicals) from drinking water, PES-UF membranes were modified by charged SMMs (Rana, D., Narbaitz, R. M., Garand-Sheridan, A.-M., Westgate, A., Matsuura, T., Tabe, S., Jasim, S. Y., 2014. Development of novel charged surface modifying macromolecule blended PES membranes to remove EDCs and PPCPs from drinking water sources. J. Mater. Chem. A 2, 10059-10072). Hence, there is a need to develop polymers to improve anti-fouling and break the trade-off between permeability and selectivity of the membranes. The design of polymers and their controlled integration into the active polyamide layer is needed to alter the membrane surface properties. Permanently charged polymers are considered anti-fouling polymers, play a crucial role in controlling the performance of the membranes.

In view of the foregoing, it is one object of the present disclosure to develop a composite membrane for desalination. The composite membrane may contain an active layer that can improve anti-fouling behavior and break the trade-off between permeability and selectivity. A second object of the present disclosure is to provide a method of making the composite membrane. A third object of the present disclosure is to provide a desalination process to provide fresh water from saline sources.

### SUMMARY

In an exemplary embodiment, a composite membrane for desalination is described. The composite membrane includes a polyethylene terephthalate (PET) nonwoven layer having a fibrous structure including a plurality of PET fibers. In some embodiments, the PET nonwoven layer has an average thickness of about 30 to 200 micrometers (μm). The composite membrane further includes a polysulfone (PS) layer disposed on a surface of the PET nonwoven layer. In some embodiments, the PS layer has an average thickness of about 30 to 100 μm. The composite membrane further includes a polyamide layer disposed on a surface of the PS layer including reacted units of an acyl compound, a phenylenediamine monomer, and a poly-(DADMAC-co-DADA). In some embodiments, the poly-(DADMAC-co-DADA) has a formula (I), and n is a positive integer.

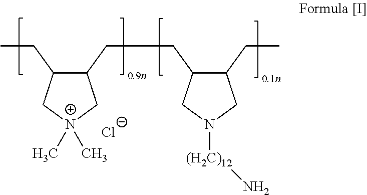

In some embodiments, the polyamide layer has a rough surface including a plurality of irregular-sized ridge- and -valley structures of polyamide.

In some embodiments, the PET nonwoven layer has an average thickness of about 50 to 100 μm.

In some embodiments, the PS layer has an average thickness of about 40 to 80 μm.

In some embodiments, the PS layer includes an inner sponge sublayer adjacent to and above the PET nonwoven layer, and a finger-like porous sublayer adjacent to and below the polyamide layer. In some embodiments, the inner sponge sublayer includes a plurality of macro voids having an average void size of 100 to 2000 nanometers (nm). In some embodiments, the finger-like porous sublayer includes a plurality of finger-like porous structures having an average length of 20 to 50 μm, and the plurality of finger-like porous structures are vertically aligned along a surface of the composite membrane.

In some embodiments, the composite membrane has a water contact angle of 20 to 65°.

In some embodiments, the composite membrane has an arithmetical mean height (Sa) of 15 to 95 nm.

In some embodiments, the composite membrane has a root means square height (Sq) of 20 to 125 nm.

In some embodiments, the composite membrane has a maximum peak height (Sp) of 85 to 420 nm.

In some embodiments, the composite membrane has a maximum pit height (Sv) of −850 to −50 nm.

In some embodiments, the composite membrane has a permeation flux of 20 and 60 L/m² hr.

In some embodiments, the composite membrane has a salt rejection of at least 90% based on an initial weight of the salt in a salt solution.

In another exemplary embodiment, a method of making the composite membrane is described. The method includes mixing monomers of diallydimethylammonium chloride (DADMAC), N¹, N¹-diallyldodecane-1,12-diammonium chloride (DADAC) in a first solvent in the presence of 2,2′-Azobis(2-methylpropionamidine) dihydrochloride (AMPD) to form a first mixture. The method further includes heating the first mixture thereby polymerizing the monomers of DADMAC and DADAC to form a poly-(DADMAC-co-DADAC) of formula (II) in a first crude mixture.

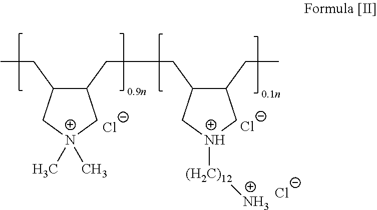

The method further includes dialyzing the poly-(DADMAC-co-DADAC) in the presence of a base and drying to form the poly-(DADMAC-co-DADA). The method further includes mixing and dissolving a polysulfone (PS) polymer in a second solvent and degassing to form a PS solution. The method further includes drop casting the PS solution onto the surface of the PET nonwoven layer to form a sample containing a PS liquid layer. The method further includes immersing the sample in a liquid medium thereby precipitating the PS polymer from the PS solution to form the PS layer disposed on the surface of the PET nonwoven layer. The method further includes removing the sample from the PS solution, washing and drying. The method further includes dipping the sample after the drying in a second mixture containing the phenylenediamine monomer, and the poly-(DADMAC-co-DADA). The method further includes contacting the sample after the dipping with a third mixture containing the acyl compound thereby polymerizing to form the polyamide layer on the surface of the PS layer.

In some embodiments, the base is at least one selected from the group consisting of NaOH, KOH, LiOH, and Ca(OH)₂.

In some embodiments, the polysulfone polymer has a weight average molecular weight (M_{w}) of 35,000 g/mol, and a number average molecular weight (Mₙ) of about 16,000 g/mol.

In some embodiments, the second solvent is at least one selected from the group consisting of dimethylacetamide (DMA), dimethylformamide (DMF), and dimethyl sulfoxide (DMSO).

In some embodiments, the PS polymer is present in the PS solution at a concentration of 5 to 40 wt. % based on a total weight of the PS solution.

In some embodiments, the phenylenediamine monomer is m-phenylenediamine (MPD).

In some embodiments, the acyl compound is trimesoyl chloride (TMC).

In yet another exemplary embodiment, a desalination process is described. The desalination process includes passing a liquid through the composite membrane. The liquid is at least one selected from the group consisting of salty water, ocean/sea water, rejected brine, wastewater, brackish water, flowback/produced water, and waste flows.

In some embodiments, the liquid is a salty water containing sodium chloride (NaCl). The NaCl is present in the salty water at a concentration of 1 to 20 grams per liter (g/L) based on a total volume of the salty water.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow diagram of a method of making a composite membrane, according to certain embodiments;

FIG. 2A is a schematic illustration of a synthesis and surface chemistry of a pristine polyamide reverse osmosis (RO) membrane, according to certain embodiments;

FIG. 2B is a schematic illustration of a synthesis and surface chemistry of a poly-(DADMAC-co-DADA) grafted membrane, according to certain embodiments;

FIG. 3 is a schematic illustration of a synthesis of poly(DADMAC-co-DADAC) and poly(DADMAC-co-DADA) containing quaternary and tertiary nitrogen, according to certain embodiments;

FIG. 4 shows a thermogravimetric analysis (TGA) curve of poly(DADMAC-co-DADAC), according to certain embodiments;

FIG. 5 shows viscosity plots of poly(DADMAC-co-DADAC), according to certain embodiments;

FIG. 6 shows proton nuclear magnetic resonance (¹H NMR) spectra of compounds 1, 2, 3, and 5 in D₂O, according to certain embodiments;

FIG. 7 shows carbon-13 nuclear magnetic resonance (¹³C NMR) spectra of compounds 1, 2, 3, and 5 in D₂O, according to certain embodiments;

FIG. 8A shows a scanning electron microscope (SEM) image of M-0 at a scale bar of 5 μm, according to certain embodiments;

FIG. 8B shows an SEM image of M-0 at a scale bar of 2 μm, according to certain embodiments;

FIG. 8C shows an SEM image of M-0 at a scale bar of 1 μm, according to certain embodiments;

FIG. 8D shows an SEM image of M-1 at a scale bar of 5 μm, according to certain embodiments;

FIG. 8E shows an SEM image of M-1 at a scale bar of 2 μm, according to certain embodiments;

FIG. 8F shows an SEM image of M-1 at a scale bar of 1 μm, according to certain embodiments;

FIG. 8G shows an SEM image of M-2 at a scale bar of 5 μm, according to certain embodiments;

FIG. 8H shows an SEM image of M-2 at a scale bar of 2 μm, according to certain embodiments;

FIG. 8I shows an SEM image of M-2 at a scale bar of 1 μm, according to certain embodiments;

FIG. 9A shows a cross-sectional view of M-0, and corresponding images ‘A1’ and ‘A2’ show magnified cross-sectional views of M-0, according to certain embodiments;

FIG. 9B shows a cross-sectional view of M-1, and corresponding images ‘B1’ and ‘B2’ show magnified cross-sectional views of M-1, according to certain embodiments;

FIG. 9C shows a cross-sectional view of M-2, and corresponding images ‘C1’ and ‘C2’ show magnified cross-sectional views of M-2, according to certain embodiments;

FIG. 10 shows a cross-sectional field emission scanning electron microscope (FE-SEM) image of the pristine membrane, according to certain embodiments;

FIG. 11A shows an energy-dispersive X-ray (EDX) spectra, according to certain embodiments;

FIG. 11B shows an elemental mapping of poly(DADMAC-co-DADA) functionalized membranes, according to certain embodiments;

FIG. 11C shows an element map of carbon for the poly(DADMAC-co-DADA) functionalized membrane, according to certain embodiments;

FIG. 11D shows an element map of nitrogen for the poly(DADMAC-co-DADA) functionalized membrane, according to certain embodiments;

FIG. 11E shows an element map of sulfur for the poly(DADMAC-co-DADA) functionalized membrane, according to certain embodiments;

FIG. 11F shows an element map of oxygen for the poly(DADMAC-co-DADA) functionalized membrane, according to certain embodiments;

FIG. 12A shows a two-dimensional (2D) view of the atomic force microscopy (AFM) analysis of M-0, according to certain embodiments;

FIG. 12B shows a three-dimensional (3D) view of the AFM analysis of M-0, according to certain embodiments;

FIG. 12C shows a 2D view of the AFM analysis of M-1, according to certain embodiments;

FIG. 12D shows a 3D view of the AFM analysis of M-1, according to certain embodiments;

FIG. 12E shows a 2D view of the AFM analysis of M-2, according to certain embodiments;

FIG. 12F shows a 3D view of the AFM analysis of M-2, according to certain embodiments;

FIG. 13 shows a Fourier Transform Infrared (FTIR) spectroscopy analysis of the pristine and the poly(DADMAC-co-DADA) functionalized membranes, according to certain embodiments;

FIG. 14 shows TGA analysis of the pristine and the poly(DADMAC-co-DADA) functionalized membranes in a temperature range of 25 to 800° C., according to certain embodiments;

FIG. 15A shows a water contact angle on a surface of the pristine and poly(DADMAC-co-DADA) functionalized membrane M-0, according to certain embodiments;

FIG. 15B shows a water contact angle on the surface of the pristine and poly(DADMAC-co-DADA) functionalized membrane M-1, according to certain embodiments;

FIG. 15C shows a water contact angle on the surface of the pristine and poly(DADMAC-co-DADA) functionalized membrane M-2, according to certain embodiments;

FIG. 15D is a histogram showing the value of the water contact angles on the surface of the membranes M-0, M-1, and M-2, according to certain embodiments;

FIG. 16 shows pure water permeation flux through the pristine and functionalized membranes M-0, M-1, and M-2 at an applied pressure of 45 bar and a feed temperature of 23° C., according to certain embodiments;

FIG. 17A shows permeation flux through the membranes M-0, M-1, and M-2 at an applied pressure of 45 bar and a feed temperature of 23° C., according to certain embodiments;

FIG. 17B shows rejection of 2000 ppm of NaCl salts through the membranes M-0, M-1, and M-2 at an applied pressure of 45 bar and a feed temperature of 23° C., according to certain embodiments;

FIG. 18 shows performance of the pristine and the poly(DADMAC-co-DADA) functionalized membranes for brackish water desalination (10000 ppm) at an applied pressure of 45 bar and a feed temperature of 23° C., according to certain embodiments;

FIG. 19A shows fouling behavior of the pristine and the poly(DADMAC-co-DADA) functionalized membranes in the presence of 2000 ppm of cetyltrimethylammonium bromide (CTAB), according to certain embodiments;

FIG. 19B shows flux recovery ratio (FRR) and irreversible flux recovery ratio (IRF) of the pristine membrane and poly(DADMAC-co-DADA) functionalized membranes after 10 hours of fouling with 2000 ppm of CTAB, according to certain embodiments; and

FIG. 20 shows the anti-fouling mechanism of the poly(DADMAC-co-DADA) functionalized membrane, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term “membrane” as used herein refers to a porous structure that is capable of separating components of a homogeneous or heterogeneous fluid. In particular, “pores” in the sense of the present disclosure indicate voids allowing fluid communication between different sides of the structure. More particular in use when a homogeneous or heterogeneous fluid is passed through the membrane, some components of the fluid can pass through the pores of the membrane into a “permeate stream”, while some components of the fluid can be retained by the membrane and can thus accumulate in a “retentate” and/or some components of the fluid can be rejected by the membrane into a “rejection stream”. Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, the term “filtration” refers to the mechanical or physical operation that can be used for separating components of homogeneous or heterogeneous solutions.

Aspects of the present disclosure are directed to a composite membrane for desalination. The composite membrane is also referred to as a membrane. The membrane includes poly(DADMAC-co-DADA) layer grafted on the polyamide active layer via its rationally designed anchoring points of NH₂ groups. The in-situ grafting resulted in a cross-linked polyamide active layer containing positively charged brushes of poly (DADMAC-co-DADA) at regular intervals.

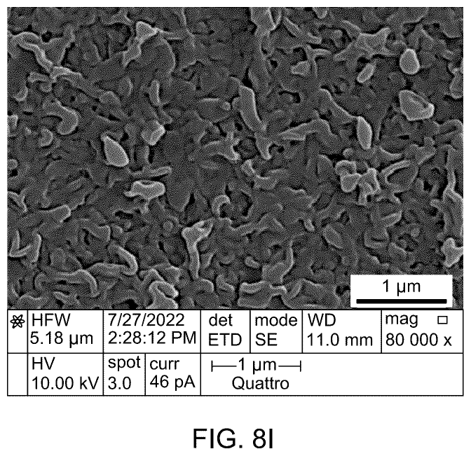

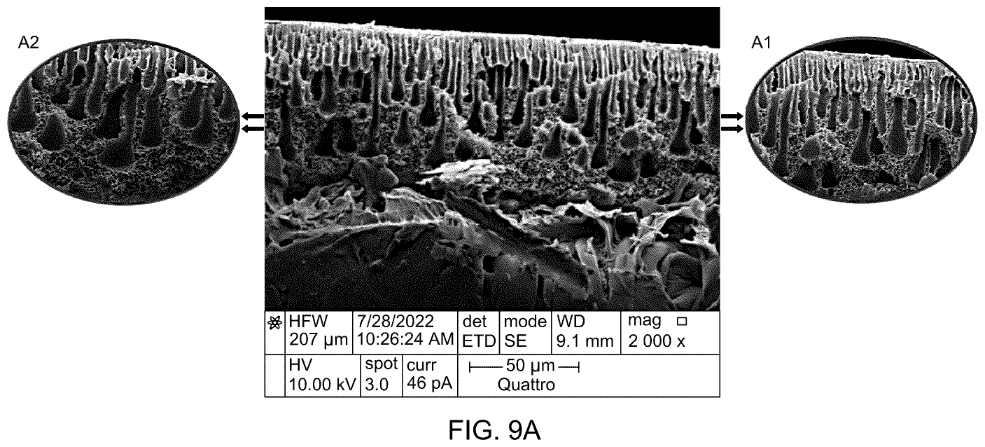

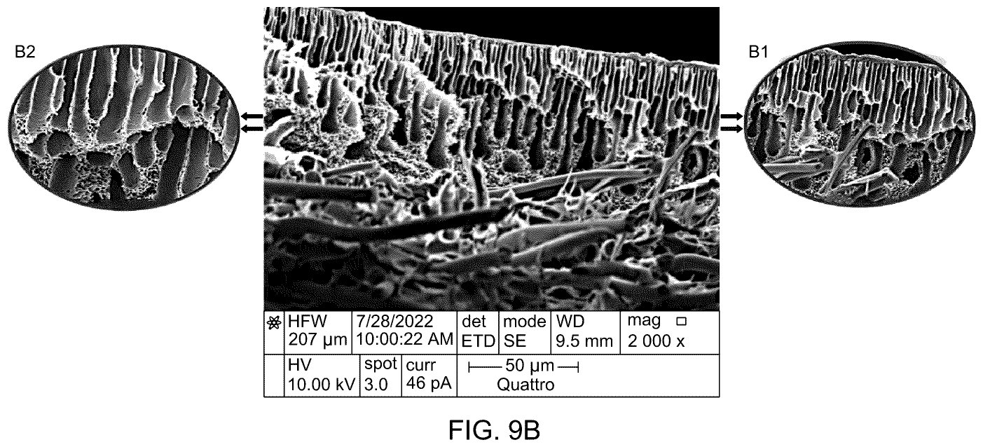

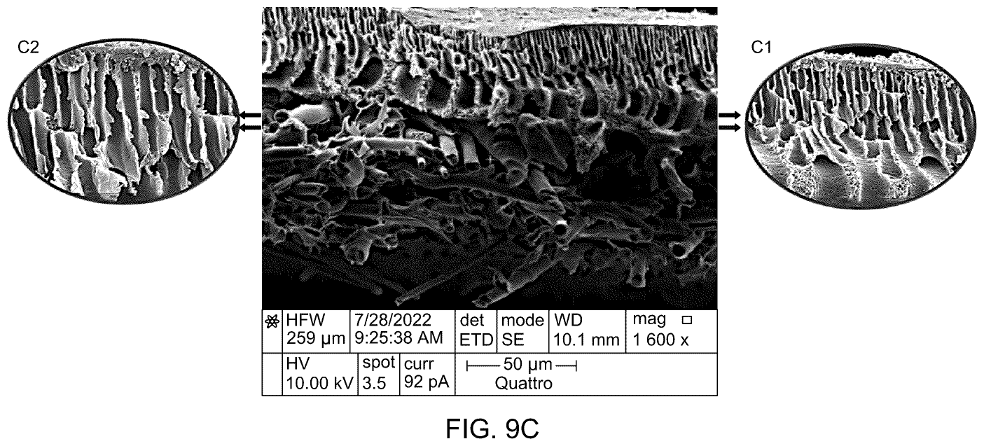

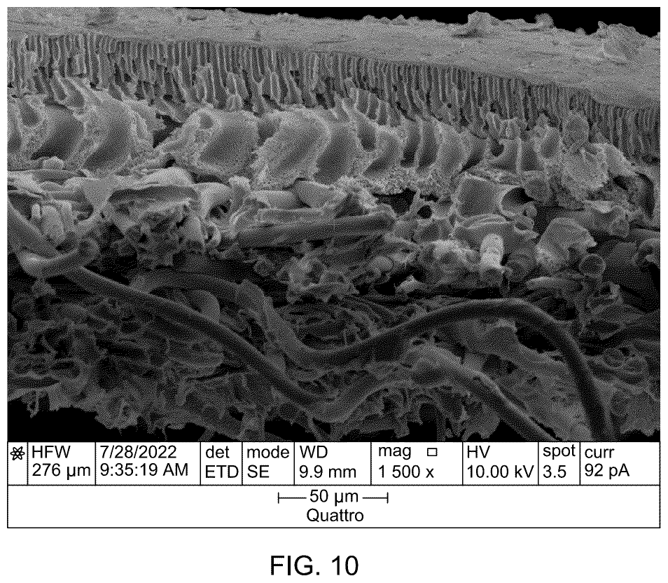

The composite membrane includes a polyethylene terephthalate (PET) nonwoven layer having a fibrous structure. In some embodiments, the fibrous structure contains a plurality of PET fibers that are stacked such that their directions are multiaxial, and resulting in the formation of the PET nonwoven layer, as depicted in FIGS. 9A to 9C, and FIG. 10. In some further embodiments, the PET nonwoven layer may be the support layer of the composite membrane. Optionally, other polymers may also be used alone or in combination with the PET nonwoven layer. Suitable examples of such polymers include, but are not limited to, polysulfone, polyethersulfone, polyether ether ketone, polyvinyl chloride (PVC), polyvinylidene dichloride (PVDC), chlorinated polyvinylchloride (CPVC), polyvinylidene difluoride (PVDF), polyvinyl fluoride (PVF), other fluoropolymers or co-polymers, cellulose acetate, cellulose nitrate, cellulose triacetate, cellulose butyrate, polyacrylonitrile, sulfonated polyether ether ketone, sulfonated polysulfone, sulfonated polyethersulfone, polyimides, polyamides, polymethyl methacrylate, polystyrene, or blends or copolymers of the above. In a preferred embodiment, the PET is the only polymer in the support layer. PET polymers are generally used for their high tensile strength. Individual monomer units of terephthalate are joined together to form PET in the form of a fibrous structure. The fibrous structure includes woven, knitted, braided, nonwoven structures, and/or combinations thereof. In a preferred embodiment, the PET includes one or more nonwoven layers.

In some embodiments, the PET nonwoven layer has an average thickness of about 30 to 200 micrometers (μm), preferably 40-190 μm, preferably 41 to 180 μm, preferably 42 to 170 μm, preferably 43 to 160 μm, preferably 44 to 150 μm, preferably 45 to 140 μm, preferably 46 to 130 μm, preferably 47 to 120 μm, preferably 48 to 110 μm, preferably 49 to 100 μm. In a preferred embodiment, the average thickness of the PET nonwoven layer is in the range of 50 to 100 μm; however, this thickness can be modified or adjusted based on the desired mechanical properties of the membrane. Other ranges are also possible.

The composite membrane further includes a polysulfone (PS) layer disposed on the surface of the PET nonwoven layer, as depicted in FIGS. 9A to 9C, and FIG. 10. The polysulfone used in the PS layer is one or more selected from polysulfone (PSU), polyethersulfone (PES/PESU), and polyphenylene sulfone (PPSU). Polysulfone polymers of the present disclosure have a wide applicability of pH, improved thermal and mechanical properties, resist compaction, and chlorine resistance. In some embodiments, the polysulfone polymers of the present disclosure have a weight-average molecular weight (M_{w}) of 10,000 to 80,000 g/mol, preferably 15,000 to 70,000 g/mol, preferably 20,000 to 60,000 g/mol, preferably 25,000 to 50,000 g/mol, preferably 30,000 to 40,000 g/mol, or even more preferably about 35,000 g/mol. In some embodiments, the polysulfone polymers of the present disclosure have a number-average molecular weight (Mₙ) of 3,000 to 40,000 g/mol, preferably 6,000 to 35,000 g/mol, preferably 9,000 to 30,000 g/mol, preferably 12,000 to 25,000 g/mol, preferably 15,000 to 20,000 g/mol, or even more preferably about 16,000 g/mol. Other ranges are also possible. In some further embodiments, the PS-based membrane is further improved by surface modifications. Accordingly, a polyamide layer is disposed on the surface of the PS layer. In some embodiments, the PS layer has an average thickness of about 30 to 100 μm, preferably 35 to 90 μm, preferably 40 to 80 μm. Other ranges are also possible.

In some embodiments, the PS layer may include one or more sub-layers. In a specific embodiment, the PS layer includes an inner sponge sub-layer adjacent to and above the PET nonwoven layer, as depicted in FIGS. 9A to 9C, and FIG. 10. The inner sponge sub-layer includes a plurality of macro voids having an average size of 100 to 2000 nanometers (nm), preferably 200 to 1800 nm, preferably 400 to 1600 nm, preferably 600 to 1400 nm, preferably 800 to 1200 nm, or even more preferably about 1000 nm. Other ranges are also possible. The PS layer further includes a finger-like porous sublayer adjacent to and below the polyamide layer, as depicted in FIGS. 9A to 9C, and FIG. 10. In some embodiments, the finger-like porous sublayer includes several finger-like porous structures having an average length of 10 to 100 μm, preferably 20 to 80 μm, preferably 30 to 60 μm, or even more preferably 40 to 50 μm. In some embodiments, finger-like porous structures are vertically aligned along the surface of the composite membrane. Other ranges are also possible.

In some embodiments, the polyamide layer includes reacted units of an acyl compound, a phenylenediamine monomer, and a poly-(DADMAC-co-DADA). In some embodiments, the acyl compound is at least one selected from the group consisting of trimesoyl chloride (TMC), terephthaloyl chloride, isophthaloyl chloride, nonanoyl chloride, adipic acid dichloride and 2,2′, 4, 4′-biphenyl tetracarboxyl chloride. In a preferred embodiment, the acyl compound is 1,3,5-trimesoyl chloride. In some embodiments, the phenylenediamine monomer includes at least one selected from the group consisting of 1,2-phenylenediamine, 1,3-phenylenediamine, 1,4-phenylenediamine, 2,4-diaminotoluene, 2,6-diaminotoluene. In some further embodiments, the phenylenediamine monomer may further contain one or more of 1,2-xylylene diamine, 1,3-xylylenediamine, 1,4-xylylenediamine, 1,3,5-triaminobenzene, ethylenediamine, 1,3-propylenediamine, 1,4-butanediamine, tris (2-aminoethyl) amine, 1,2-diaminocyclohexane, 1,3-diaminocyclohexane, 1,4-diaminocyclohexane and piperazine. In some preferred embodiments, the phenylenediamine monomer is meta-phenylenediamine monomer (MPD). In some embodiments, the poly-(DADMAC-co-DADA) is a compound of formula (I), in which n is a positive integer.

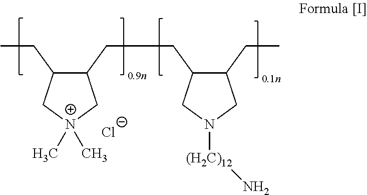

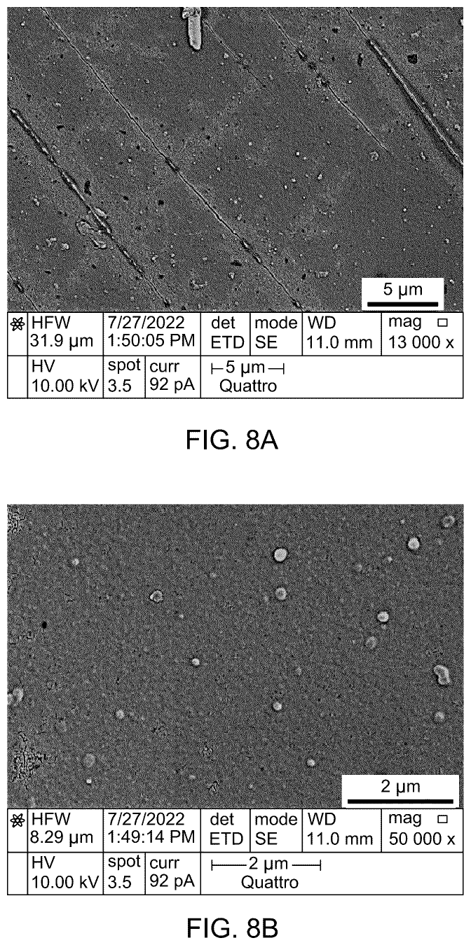

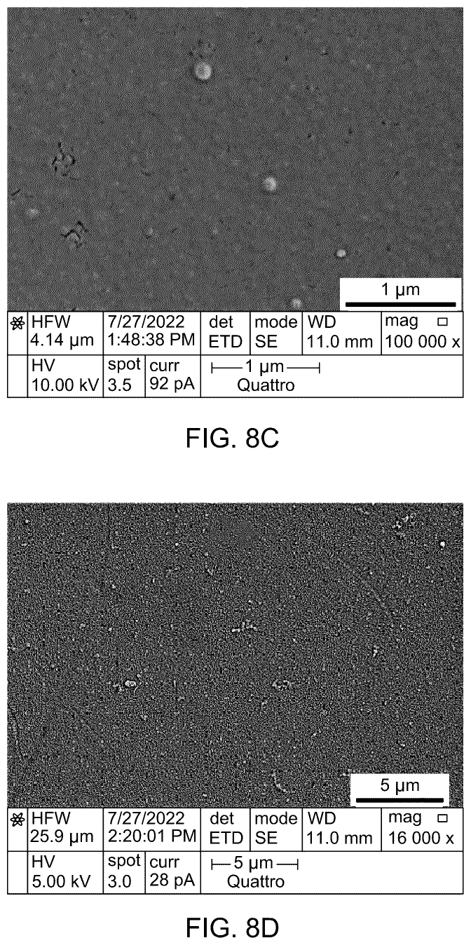

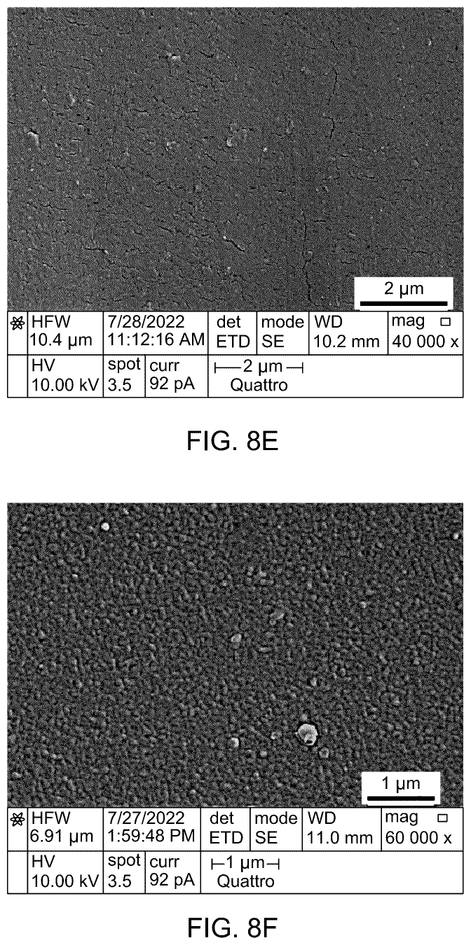

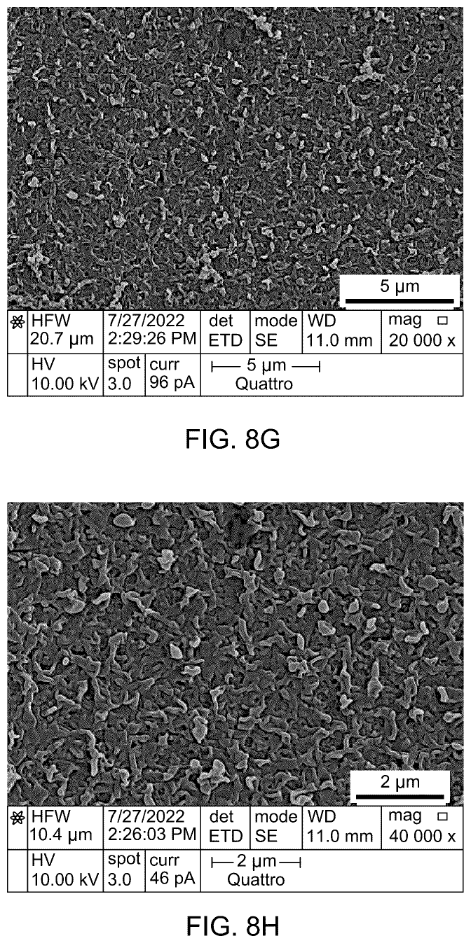

Generally, the polyamide layer has a rough surface owing to the grafting of poly-(DADMAC-co-DADA) to form the polyamide layer of the membrane. The polyamide layer is one or more irregular-sized ridge-and-valley structures of polyamide, as depicted in FIGS. 8G to 8I.

As used herein, the term “rough surface” or “rough surface morphology” generally refers to the physical characteristics or features of a surface that deviate from smoothness or regularity. The term “rough surface morphology” may include unevenness, irregularities, and variations in height, shape, or texture of a surface at a micro or macro scale. In the present disclosure, the rough surface morphology of the polyamide layer includes, but is not limited to, bumps, ridges, valleys, peaks, or irregular shapes that may be randomly distributed or organized in a specific pattern. Additionally, the surface roughness may be determined by roughness average (Ra), root mean square (RMS) roughness, or peak-to-valley height. Roughness average (Ra) is calculated by averaging the surface roughness of at least 5, and preferably at least 10, representative locations spaced approximately evenly across the portion of the polyamide layer. In some embodiments, it is preferred to measure the thickness at representative points across the longest dimension of the portion of the article that is covered with the polyamide layer. The standard deviation of roughness is found by calculating the standard deviation of the local average roughness across at least 5, and preferably at least 10, representative locations spaced approximately evenly across the portion of the polyamide layer. Arithmetic average roughness (Sa) is the areal (3D) equivalent of two-dimensional Ra. Sa generally refers to the average height of all measured points in the areal measurement. The roughness refers to surface micro-roughness which may be different than measurements of large-scale surface variations. In some embodiments, this may be measured using atomic force microscopy (AFM).

In some embodiments, the polyamide layer of the composite membrane has an Arithmetic average roughness (Sa) of 1 to 200 nm, preferably 5 to 180 nm, preferably 10 to 150 nm, preferably 20 to 120 nm, preferably 30 to 90 nm, or even more preferably 50 to 60 nm. Other ranges are also possible.

In some embodiments, the polyamide layer of the composite membrane has a root mean square roughness (Sq) of 1 to 200 nm, preferably 10 to 180 nm, preferably 20 to 150 nm, preferably 30 to 120 nm, preferably 50 to 90 nm, or even more preferably 60 nm. Other ranges are also possible.

In some embodiments, the polyamide layer of the composite membrane has a maximum peak height (Sp) of 10 to 800 nm, preferably 20 to 600 nm, preferably 40 to 400 nm, preferably 60 to 200 nm, preferably 80 to 100 nm, or even more preferably 90 nm. Other ranges are also possible.

In some embodiments, the polyamide layer of the composite membrane has a maximum pit height (Sv) of −2000 to −10 nm, preferably −1500 to −20 nm, preferably −1000 to −40 nm, preferably −500 to −60 nm, preferably −200 to −80 nm, or even more preferably −100 nm. Other ranges are also possible.

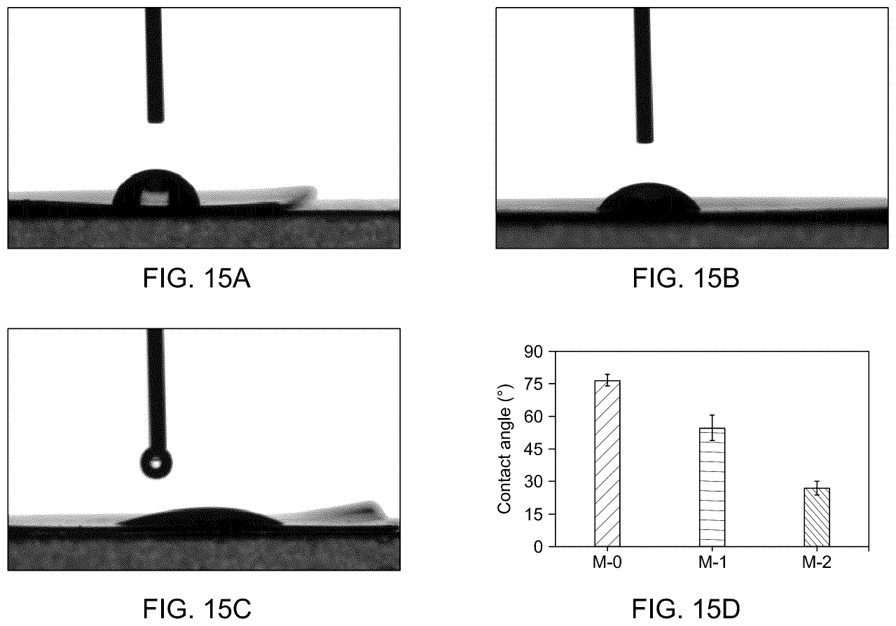

Referring to FIGS. 15A to 15D, the water contact angle was obtained by the sessile drop method on the polyimide membrane surface by using a contact angle goniometer instrument, e.g., DM-501, Kyowa Interface Science Co. Ltd., Japan. The water contact angle WCA was taken on at least two, preferably at least four different positions on the polyimide layer of the composite membrane and the average value was recorded. The thickness of the membranes was recorded by taking measurements from at least 5, preferably at least 10 different spots on the polyimide membrane to generate corresponding data using LITEMATIC VL-50A, manufactured by Mitutoyo measuring instrument.

In some embodiments, the composite membrane has a water contact angle of 20 to 65° preferably 25 to 64°, preferably 30 to 63°, preferably 35 to 62°, preferably 40 to 61°, preferably 50 to 60°. In some embodiments, the composite membrane has an arithmetical mean height (Sa) of 15 to 95 nm, preferably 16 to 90 nm, preferably 17 to 90 nm, preferably 20 to 90 nm, preferably 30 to 90 nm, preferably 40 to 90 nm, preferably 50 to 90 nm, preferably 60 to 90 nm, preferably 70 to 90 nm, preferably 80 to 90 nm, preferably 85 to 90 nm, preferably 88 to 90 nm, preferably 89 to 90 nm. In some embodiments, the composite membrane has a root means square height (Sq) of 20 to 125 nm. In some embodiments, the composite membrane has a maximum peak height (Sp) of 85 to 420 nm, preferably 89 to 410 nm, preferably 89.1 to 409.2 nm, preferably 100 to 409.2 nm, preferably 200 to 409.2 nm, preferably 300 to 409.2 nm, preferably 400 to 409.2 nm, preferably 405 to 409.2 nm, preferably 409.2 nm. In some embodiments, the composite membrane has a maximum pit height (Sv) of −850 to −50 nm, preferably −840 to −53.1 nm, preferably −100 to −840 nm, preferably −200 to −840 nm, preferably −300 to −840 nm, preferably −400 to −840 nm, preferably −500 to −840 nm, preferably −600 to −840 nm, preferably −700 to −840 nm, preferably −800 to −840 nm, preferably −830 to −840 nm, preferably −835 to −840 nm, preferably −836.6 nm. Other ranges are also possible.

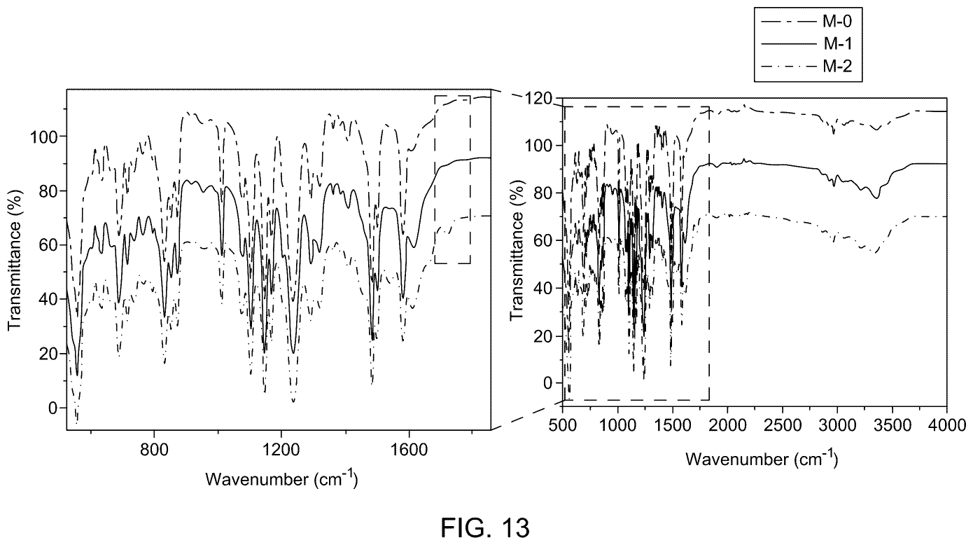

The structures of the composite membranes may be characterized by Fourier-transform infrared spectroscopy (FT-IR). In some embodiments, the FT-IR are collected in a Nicolet iS10 series acquired in a range of 4500 to 400 centimeter inverse (cm⁻¹) at 4 cm⁻¹ resolution. At least 5, at least 10, or preferably at least 20 scans were carried out for each sample. In some embodiments, the polyimide membrane (M-0) prepared in the absence of poly-(DADMAC-co-DADA) has peaks at 500 to 600 cm⁻¹, 650 to 750 cm⁻¹, 800 to 900 cm⁻¹, 1100 to 1150 cm⁻¹, 1150 to 1750 cm⁻¹, and 3000 to 3500 cm⁻¹ in the FT-IR spectrum, confirming its formation as depicted in FIG. 13. In some embodiments, the polyimide membrane in the presence of poly-(DADMAC-co-DADA) has peaks at 500 to 600 cm⁻¹, 650 to 850 cm⁻¹, 850 to 1100 cm⁻¹, 1100 to 1500 cm⁻¹, 1500 to 1750 cm⁻¹, and 3000 to 3500 cm⁻¹ in the FT-IR spectrum, confirming its formation as depicted in FIG. 13. Other ranges are also possible.

¹H and ¹³C NMR spectra may be recorded on a 400 MHz spectrometer (Bruker spectrometer) using the residual D₂O protons (HOD) at δ 4.65 ppm, and ¹³C dioxane signal at δ 67.4 ppm as internal standards.

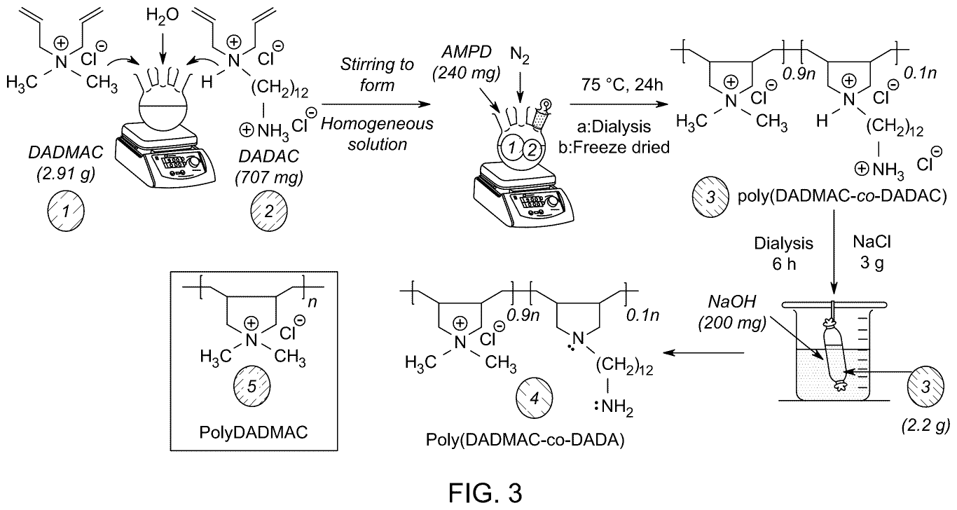

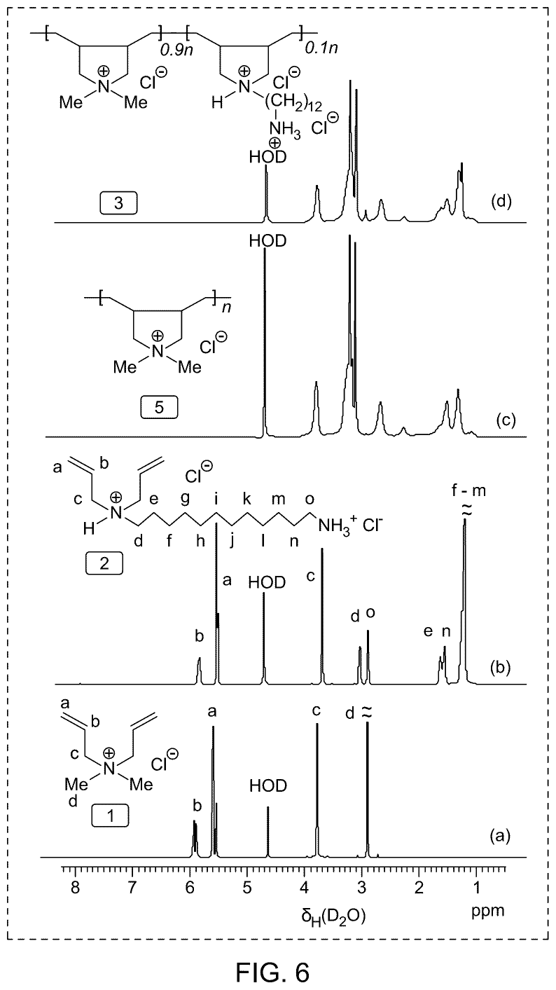

Referring to FIGS. 3 and 6, ¹H NMR spectra of the poly-(DADMAC-co-DADAC) of formula (II) (also referred as molecule 3 in FIGS. 3 and 6) in D₂O. In some embodiments, the poly-(DADMAC-co-DADAC) of formula (II) has peaks in a range of 0.5 to 6, or more preferably about 1-2, about 2.5-3, about 3-3.5, about 3.5-4, and about 4-5.5. Other ranges are also possible.

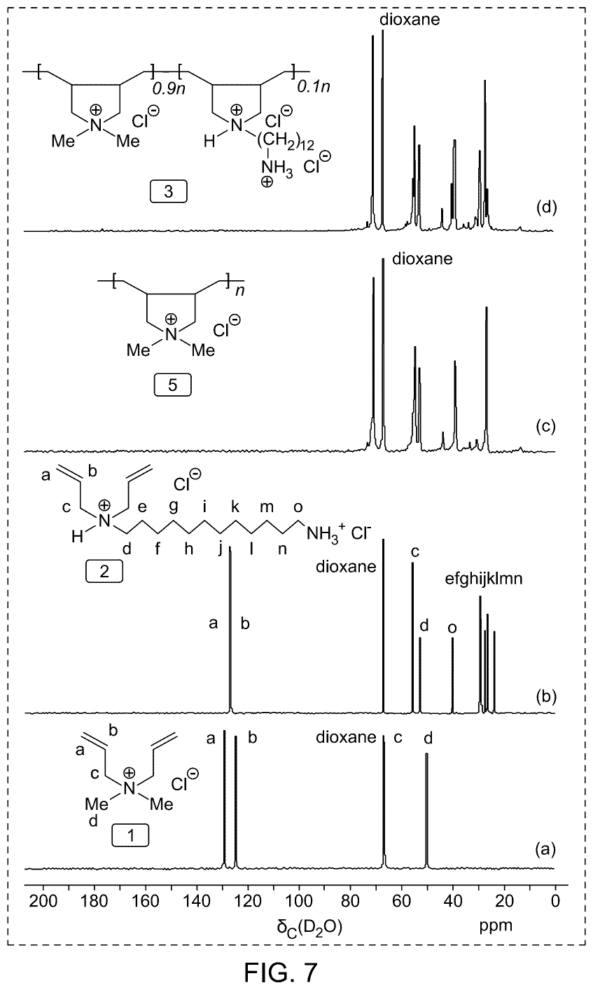

Referring to FIGS. 3 and 7, ¹³C NMR spectra of the poly-(DADMAC-co-DADAC) of formula (II) (also referred as molecule 3 in FIGS. 3 and 7) in ¹³C dioxane. In some embodiments, the poly-(DADMAC-co-DADAC) of formula (II) has peaks in a range of 10 to 80, or more preferably about 20-40, about 40-50, about 50-60, about 60-70, and about 70-80. Other ranges are also possible.

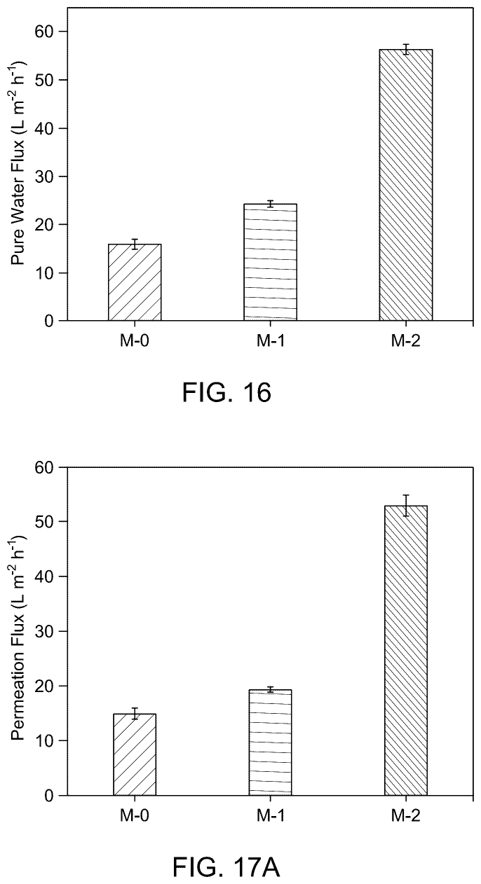

FIG. 16 illustrates pure water permeation flux through the pristine and functionalized membranes at an applied pressure of 10 to 80 bar, preferably about 45 bar and a feed temperature of about 23° C. In some embodiments, the composite membrane has a pure water permeation flux of 20 and 60 L/m² hr, preferably 22 to 56 L/m² hr, or even more preferably 24.3 to 56.5 L/m² hr. Other ranges are also possible.

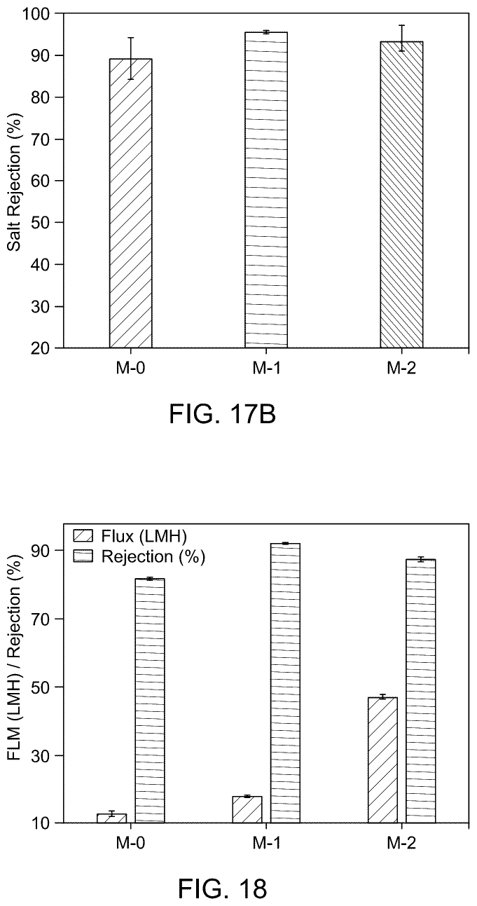

FIG. 17A illustrates saltwater permeation flux through the pristine and functionalized membranes at an applied pressure of 10 to 80 bar, preferably about 45 bar and a feed temperature of about 23° C. In some embodiments, the composite membrane has a saltwater permeation flux of 20 and 60 L/m² hr, preferably 22 to 56 L/m² hr, or even more preferably 24.3 to 56.5 L/m² hr. In some embodiments, the saltwater solution contains one or more salts such as sodium chloride (NaCl). In some embodiments, the NaCl is present in the saltwater solution at a concentration of 200 to 10,000 ppm, preferably 800 to 8,000 ppm, preferably 1,600 to 6,000 ppm, or even more preferably 2,000 to 4,000 ppm, based on a total weight of the saltwater solution. Other ranges are also possible.

FIG. 17B illustrates saltwater rejection through the pristine and functionalized membranes at an applied pressure of 10 to 80 bar, preferably about 45 bar and a feed temperature of about 23° C. In some embodiments, the composite membrane has a salt rejection of at least 90%, preferably 91%, preferably 92%, preferably 93%, preferably 94%, preferably 95%, preferably 96%, preferably 97%, preferably 98%, preferably 99%, preferably >99%, based on the initial weight of the salt in a salt solution. Other ranges are also possible.

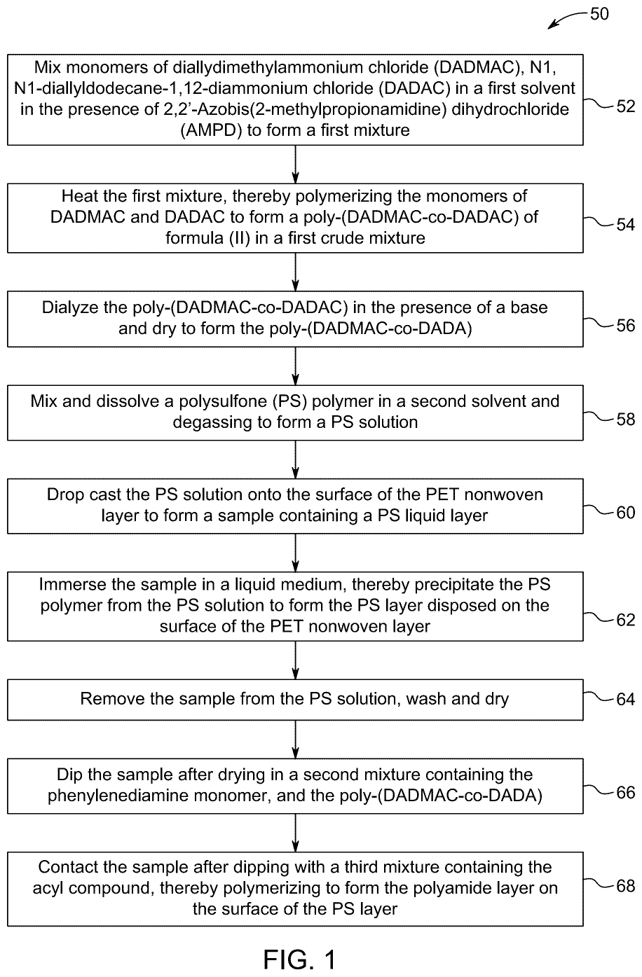

Referring to FIG. 1, a schematic flow diagram of a method 50 of making the membrane is illustrated. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes mixing monomers of diallydimethylammonium chloride (DADMAC), N¹, N¹-diallyldodecane-1,12-diammonium chloride (DADAC) in a first solvent in the presence of 2,2′-Azobis(2-methyl propionamidine) dihydrochloride (AMPD) to form a first mixture. In an embodiment, the weight ratio of DADMAC to DADAC in the first solvent is in a range of 1:5 to 5:1, preferably 4:1 to 1:1, 4:1, preferably 3:1. In an embodiment the molar ratio of the DADMAC to DADAC in the first solvent is in the range of 5:1 to 10:1, preferably 5:1, preferably 6:1, preferably 7:1, preferably 8:1, preferably 9:1. The monomers are mixed in the first solvent, using a stirring rod or a stirrer. The first solvent may be an aqueous, organic, or a combination thereof. In a preferred embodiment, the first solvent is water. The mixing is carried out in the presence of the AMPD, which acts as the initiator. Optionally, other initiators conventionally known in the art may also be used. Generally, the initiator is added in small amounts, and its percentage may vary. However, it is preferred that the concentration of the AMPD is in the range of 0.1 to 0.5 mM, or even more preferably 0.2 to 0.4 mM. Other ranges are also possible.

At step 54, the method 50 includes heating the first mixture, thereby polymerizing the monomers of DADMAC and DADAC to form a poly-(DADMAC-co-DADAC) of formula (II) in a first crude mixture. The first mixture is heated at a temperature of 60-90° C., preferably 62-88° C., preferably 65-85° C., preferably 68-82° C., preferably 70-80° C., preferably 72-78° C., preferably 74-76° C., preferably 75° C. for a period of 20-30 hours, preferably 22-28 hours, preferably 24 hours to form the poly-(DADMAC-co-DADAC). It is preferred that the heating be carried out in an inert atmosphere or under nitrogen flow to flush out undesired gases formed during the polymerization reaction. The polymerization reaction forms the poly-(DADMAC-co-DADAC), which consists of repeated units of DADMAC and DADAC. The poly-(DADMAC-co-DADAC) is a compound of Formula (II).

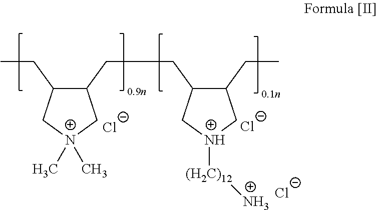

At step 56, the method 50 includes dialyzing the poly-(DADMAC-co-DADAC) in the presence of a base and drying to form the poly-(DADMAC-co-DADA). The dialysis process is carried out to separate the poly-(DADMAC-co-DADAC) of formula (II) from the first crude mixture. After separation, the poly-(DADMAC-co-DADAC) of formula (II) in the presence of a base is transformed to form the poly-(DADMAC-co-DADA). The base is at least one selected from the group consisting of NaOH, KOH, LiOH, and Ca(OH)₂. In a preferred embodiment, the base is NaOH. In some embodiments, the dialyzing may be replaced by conventional methods, such as precipitation, to separate the poly-(DADMAC-co-DADAC) from the first crude mixture.

At step 58, the method 50 includes mixing and dissolving a polysulfone (PS) polymer in a second solvent and degassing to form a PS solution. PS polymers are a group of polymers, including a sulfone group and alkyl- or aryl-groups. The polysulfone polymer may be polysulfone (PSU), polyethersulfone (PES), polyphenylene sulfone (PPSU), poly(arylene sulfone) (PAS), poly(bisphenol-A sulfone) (PSF), or some derivative of polysulfone. In a preferred embodiment, the polysulfone polymer is polysulfone (PSU). In some embodiments, the PS polymer has an average molecular weight (M_{w}) in a range of 1-3,000 kDa, preferably 5-1,000 kDa, preferably 10-100 kDa, preferably 20-60 kDa, preferably 25-50 kDa, preferably 30-40 kDa, or about 35 kDa or 35,000 g/mol and a number average molecular weight (Mₙ) of about 16,000 g/mol. Other ranges are also possible.

In some embodiments, the PS polymer, alone or in combination with other polymers such as polyvinyl chloride, polyvinylidene chloride, polyacrylonitrile, high impact polystyrene, acrylonitrile butadiene styrene, polyethylene/acrylonitrile butadiene styrene, polycarbonate/acrylonitrile butadiene styrene, acrylic polymers, polybutadiene, polyisoprene, polyacetylene, silicones, synthetic rubbers and the like, and copolymers and mixtures thereof, is dissolved in the second solvent. Suitable examples of the second solvent include, but are not limited to, pentane, hexane, cyclohexane, ethyl acetate, dichloroethane, chloroform, dimethylformamide (DMF), dimethylacetamide (DMA), N-methyl-2-pyrrolidone (NMP), N-ethylpyrrolidone (NET), formamide, triethyl phosphate (TEP), gamma-butyrolactone, epsilon-caprolactam, dimethylsulfoxide (DMSO), tetrahydrofuran (THF), acetone, piperidine, imidazole, and sulfuric acid. In a preferred embodiment, the second solvent is at least one of DMA, DMSO, and/or DMF. In one preferred embodiment, the solvent is an amide solvent. In a further embodiment, the solvent is dimethylacetamide, also written as N,N-dimethylacetamide. In one embodiment, the solvent is non-polar. In a preferred embodiment, the solvent is immiscible with water.

The PS solution may be agitated for 0.5-3 hours, preferably 1-2 hours. The agitation may encompass shaking, stirring, rotating, vibrating, sonication, and other means of agitating the solution, preferably at room temperature. The mixture may be agitated throughout the reaction by employing a rotary shaker, a magnetic stirrer, a centrifugal mixer, or an overhead stirrer. Alternatively, the mixture is left to stand (i.e., not agitated). The PS solution may be degassed to remove any air bubbles and prevent any defects in the membrane.

At step 60, the method 50 includes drop casting the PS solution onto the surface of the PET nonwoven layer to form a sample containing a PS liquid layer. The PET nonwoven layer from the substrate. Optionally, other substrates may be used as well. For example, metal mesh, sintered metal, porous ceramic, sintered glass, paper, porous non-dissolved plastic, woven or non-woven material, or carbon fiber material. The sample containing the PS liquid layer is uniformly spread on the PET nonwoven layer, the methods of which are obvious to a person skilled in the art.

At step 62, the method 50 includes immersing the sample in a liquid medium, thereby precipitating the PS polymer from the PS solution to form the PS layer disposed on the surface of the PET nonwoven layer. The immersion is carried out for about 20-24 hours, preferably 24 hours. During this time, the PS polymer present in the PS solution is precipitated on the surface of the PET nonwoven layer. In some embodiments, the PS polymer is at a concentration of 5 to 40 wt. % based on the total weight of the PS solution, preferably 10 to 35 wt. %, preferably 15 to 30 wt. %, or even more preferably 20 to 25 wt. % based on the total weight of the PS solution. Other ranges are also possible.

At step 64, the method 50 includes removing the sample from the PS solution, washing and drying. The sample was removed from the PS solution, washed with water, and dried to remove the solvent.

At step 66, the method 50 includes dipping the sample after the drying in a second mixture containing the phenylenediamine monomer, and the poly-(DADMAC-co-DADA). The phenylenediamine monomer is m-phenylenediamine (MPD). In some embodiments, the second mixture may further include triethanolamine (TEA). TEA acts as a base and helps to neutralize the HCl produced during the amine and acid chloride reaction. It also assists in the deprotonation of the MPD and improves its reaction capability. In some embodiments, other bases may be used as well. In some embodiments, the concentration of TEA in the second mixture is in a range of 0.01-10 wt. %, preferably 0.03-5 wt. %, preferably 1 to 3 wt. %, preferably 3 wt. % based on the total weight of the second mixture. Other ranges are also possible.

In some embodiments, the second mixture may further include a surfactant. Suitable examples of surfactants are sodium dodecyl sulfate (SDS), sodium dodecyl benzenesulfonate (SDBS), cetyltrimethylammonium bromide (CTAB), and sodium lauryl sulfate (SLS). In a preferred embodiment, the surfactant is SDS. The surfactant was used to activate the sample, enhance the wettability of the membrane, and enhance the interaction of the MPD with the PS support. In some embodiments, the concentration of the surfactant in the aqueous solution is in a range of 0.01-10 wt. %, preferably 0.03-5 wt. %, preferably 0.05-0.1 wt. %, preferably 0.1 wt. % based on the total weight of the second mixture. The immersion of the support into the second mixture can be carried out at room temperature—preferably at a temperature range of 20-37° C. Other ranges are also possible.

At step 68, the method 50 includes contacting the sample after the dipping with a third mixture containing the acyl compound, thereby polymerizing to form the polyamide layer on the surface of the PS layer. The acyl compound is trimesoyl chloride (TMC). In an embodiment, the TMC acts as a cross-linker. The TMC was dissolved in n-hexane to form the organic solution. In some embodiments, the concentration of TPC in the n-hexane ranges from 0.1-1, preferably 0.2-0.5, and more preferably 0.2 wt./v %. Other ranges are also possible.

The composite membrane of the present disclosure finds application in the desalination process. Desalination is the process by which the dissolved mineral salts in water are removed from a liquid. The liquid may be one or more of salty water, ocean/sea water, rejected brine, wastewater, brackish water, flow back/produced water, and waste flows. In an embodiment, the liquid is salty water. Salty water refers to water containing sodium chloride (NaCl). In an embodiment, the NaCl is present in the salty water at a concentration of 1 to 100 grams per liter (g/L) based on the total volume of the salty water, preferably 5 to 80 g/L, preferably 10 to 60 g/L, preferably 15 to 40 g/L, or even more preferably about 20 g/L. Other ranges are also possible. During the desalination process, the liquid is passed through the composite membrane. After completion of the desalination process, two products are made: clean water and highly concentrated saline water.

Another aspect of the present disclosure is directed to a desalination system containing the composite membrane. The desalination system (hereinafter referred to as “the system”), includes a water heater, recirculating chiller, thermocouple, data acquisition (DAQ); hot water tank (HT); cold water tank (CT); beaker (B); pump (PM); flowmeter (FM); pressure gauge (P); temperature gauge (T); conductivity meter (CM); weighing balance (WB); and an air gap membrane distillation (AGMD) unit. The AGMD is utilized wherein the water vapor travels through the membrane from the hot feed side (HC) to the cooling plate (CP) and is collected in a beaker after condensation.

The AGMD unit includes two or more modules. Each module includes a hot liquid compartment (HC) having a hot liquid inlet and a hot liquid outlet, and a condensation plate (CP) having a first side and a second side opposite the first side. The composite membrane disposed on at least one side of the HC such that one side of the composite membrane faces the first side of the CP. The membrane further includes an air gap compartment (AG) separates the CP and the composite membrane; and a cold liquid compartment (CC) having a cold liquid inlet and a cold liquid outlet. The CC is adjacent to the second side of the CP. The membrane further includes a permeate outlet in fluid communication with the air gap; a heating unit in fluid communication with the HC; and a cooling unit in fluid communication with the CC. The plurality of modules of the AGMD unit are connected in at least one of a series arrangement or a parallel arrangement.

The system includes two cycles—heating and cooling cycle. During the heating cycle, the feed, saline water, is introduced into the hot liquid inlet of HC through a pump (for example, a centrifugal pump), from a feed water bath, at a pre-determined flow rate. In an example, the feed water bath is heated by at least one selected from a group consisting of a space heater, heating pipes, a furnace, and a boiler, without any limitations. The FM is configured to monitor the flow rate of the feed into the HC. The temperature gauge (T) is configured to monitor the feed temperature, while the pressure gauge (P) is configured to monitor the feed pressure. The saline feed in the HC is heated to around 60-80° C., preferably about 70-75° C., using a water heater. The feed passes through the HC and returns to the feed water bath through the hot liquid outlet for re-heating and re-circulation. The temperature was maintained and monitored by connecting thermocouples to a DAQ.

During the cooling cycle, cold water from the CW is pumped into the CC through the cold liquid inlet to cool down the condensation plate located between the air gap and the CC. The cold water exists the CC through the cold liquid outlet and returns to the CW for re-cooling and re-circulation. The FM is configured to monitor the flow rate of the cold water into the CC. The temperature gauge (T) is configured to monitor the cold water temperature, while the pressure gauge (P) is configured to monitor the cold-water pressure.

The vapor pressure difference (the driving force) is created because of the temperature difference between the HC and CC. The water vapor created at the HC diffuses through the membrane pores and then migrates through the stagnant air staged between the membrane and CP. The vapor comes in contact with the CP and is condensed to form a distillate which is collected in the CC. The distillate is directed outside via a permeate outlet of the AG. The CM with TDS measurement is used to assess the quality of the collected water (distillate) in the beaker. The amount collected in the beaker is weighed at regular intervals to calculate the flux. Both the CM and WB is connected to a computer to record data for long-term test through their respective software.

The composite membrane containing the grafted poly-(DADMAC-co-DADA) showed improved performance compared to the pristine polyamide membrane that does not contain the grafted poly-(DADMAC-co-DADA). In some embodiments, the composite membrane of the present disclosure displayed a 3.5 times flux for preferably about 2000 ppm of NaCl while maintaining a rejection at about 93.1%. The anti-fouling behavior of the membranes was examined against the model positively charged CTAB (cetyltrimethylammonium bromide) foulants (2000 ppm). The composite membrane containing the grafted poly-(DADMAC-co-DADA) showed an improved anti-fouling tendency. In some embodiments, after 600 min (about 10 h) of continuous operation, the flux declined by less than 15%, whereas the pristine polyamide membrane lost about 99%. The composite membrane of the present disclosure may recover more than 93% of their maximum flux.

### EXAMPLES

The following examples demonstrate the filtration membrane. The examples are provided solely for illustration and are not to be construed as limitations of the present disclosure, as many variations thereof are possible without departing from the spirit and scope of the present disclosure.

### Example 1: Physical Methods

Atomic compositions were determined using a Perkin Elmer instrument (Model 2400). An SDT analyzer (Q600: TA Instruments) was used to perform thermogravimetric analyses (TGA) under a flow of N₂. A Thermo Scientific Nicolet iS10 spectrometer was used to record the various materials' Fourier Transform Infrared (FTIR) spectra. The lens of the spectrometer was cleaned with isopropanol to avoid any contamination. Elemental analyses were performed using a Perkin Elmer instrument (Model 2400). Under N₂ atmosphere and using CO₂-free water, the viscosities were measured by an Ubbelohde viscometer having a viscometer constant of 0.005 cSt/s at 30.0±0.1° C. using a CT72/P water bath (SI Analytics, Germany). A Bruker AvanceIII, 400 MHz spectrometer, was utilized to measure ¹H, and ¹³C, NMR spectra using the residual D₂O protons (HOD) at δ 4.65 ppm, ¹³C dioxane signal at δ 67.4 ppm as internal standards.

### Example 2: Materials

2,2′-azobis(2-methylpropionamidine) dihydrochloride (AMPD) (≥97%), diallyl dimethylammonium chloride (DADMAC), MPD, cetyltrimethylammonium bromide (CTAB), sodium dodecyl sulfate, hexane, and polysulfone with average Mw approximately about 35,000 and average Mn approximately about 16,000 were purchased from Sigma-Aldrich. Polyethylene terephthalate (PET) nonwoven support fabric named Novatexx 2413 was delivered by Freudenberg Group. 1,12 diaminododecane, ethyl formate, allyl chloride obtained from Fluka Chemie AG, were used as received. Triethanolamine was purchased from the TCI chemicals. ACS reagent grade methanol, ether, sodium hydroxide, and hydrochloric acid (37%) were purchased from Fluka AG, Buchs, Switzerland, and used as received. All water used was of Milli-Q quality. A pectra/Por (Spectrum Lab., Inc.) membrane (MWCO 3500) was used for dialysis. DADAC and polyDADMAC were synthesized as described. (Mazumder, M. A. J., Alhaffar, M. T., Ali, S. A., 2018. Immobilization of two polyelectrolytes leading to a novel hydrogel for high-performance Hg²⁺ removal to ppb and sub-ppb levels. Chemical Engineering Journal 334, 1440-1454; and Arshad, Z., Ali, S. A., 2023. Synthesis and anticorrosive application of biomimetic dopamine-based cationic polyelectrolytes derived from diallylammonium salts. Polymer (Guildf) 264, 125537, each of which is incorporated herein by reference in their entireties).

### Example 3: Synthesis of Poly(DADMAC-Co-DADAC) 3

A solution of DADMAC 1 (2.91 g, 18 mmol), monomer 2 (707 mg, 2.0 mmol), and initiator AMPD (240 mg) in H₂O (1.95 g) in a round bottom flask was stirred under N₂ at 75° C. for 24 h, as depicted in FIG. 3. The thickened mixture was dialyzed against distilled water for 24 hours. The dialyzed solution was freeze-dried to obtain poly(DADMAC-co-DADAC) 3 as a white solid (3.2 g, 88%). νₘₐₓ (KBr): 3370, 2983, 2920, 2855, 2108, 1645, 1465, 1383, 1310, 1243, 1149, 1076, 954, 646, 540, 473, and 447 cm⁻¹. (Found: C, 60.4; H, 10.5; N, 8.3%). Poly(DADMAC-co-DADAC) 3 containing incorporated monomers 1/2 in a 9:1 ratio requires C, 59.77; H, 10.14; N, 8.52%, (Found: C, 59.6; H, 10.2; N, 8.3%).

### Example 4: Synthesis of poly(DADMAC-co-DADA) 4

NaOH (200 mg, 5 mmol) was added into a dialysis bag containing a solution of 3 (2.2 g, containing 10.9 mmol of repeating unit of monomer 1 and 1.22 mmol of monomer 2) in H₂O (20 mL), as depicted in FIG. 3. After the addition of NaCl (3 g), the slightly cloudy mixture was dialyzed against distilled water for 6 h to obtain 4 (1.8 g, 95% yield). νₘₐₓ (KBr): 3373, 3012, 2928, 2856, 2075, 1678, 1625, 1463, 1306, 1208, 964, 892, 650, 592, 534, 459, and 424 cm⁻¹. (Found: C, 61.8; H, 10.7; N, 8.5%). poly(DADMAC-co-DADA) 4 containing incorporated monomers 1/2 (2 in amine form) in a 9:1 ratio requires C, 62.28; H, 10.45; N, 8.88%, (Found: C, 62.2; H, 10.5; N, 8.7%).

### Example 5: Synthesis of poly(DADMAC) 5

Monomer 1 (1.62 g, 10 mmol) was dissolved in 0.87 g of water, followed by the addition of AMPD (75 mg). The reaction mixture was heated at 65° C. in a closed flask under N₂ for 24 h, as depicted in FIG. 3. Within 4 h, the mixture becomes solidified. The dialysis against distilled water was carried out in a 3500 MWCO bag for 24 h, followed by freeze-drying, which yielded white solid polymer 5 (1.4 g, 86%).

### Example 6: Synthesis of Pristine and Poly-(DADMAC-Co-DADA) Grafted Membranes

A polysulfone (PS) support has been prepared according to the previously reported method (Baig, N., Matin, A., Faizan, M., Anand, D., Ahmad, I., Khan, S. A., 2022b. Antifouling low-pressure highly permeable single step produced loose nanofiltration polysulfone membrane for efficient Erichrome Black T/divalent salts fractionation. J Environ Chem Eng 10, 108166, which is incorporated herein by reference in its entirety). PS beads were kept in an oven at 50° C., vacuumed, and dried overnight. An 18% solution of PS was prepared in dimethylacetamide at room temperature. After completely dissolving the PS pellets, the PS solution was degassed for about 30 minutes and kept for more than 24 hours to release all the trapped bubbles. The PS solution was cast on the polyester non-woven support with the help of the membrane applicator. After casting, it was dipped for 10 min into the coagulation bath to solidify the membrane. After that, the PS support membrane was removed from the coagulation bath and kept in deionized water for another 24 hours to complete the phase inversion and solvent removal process.

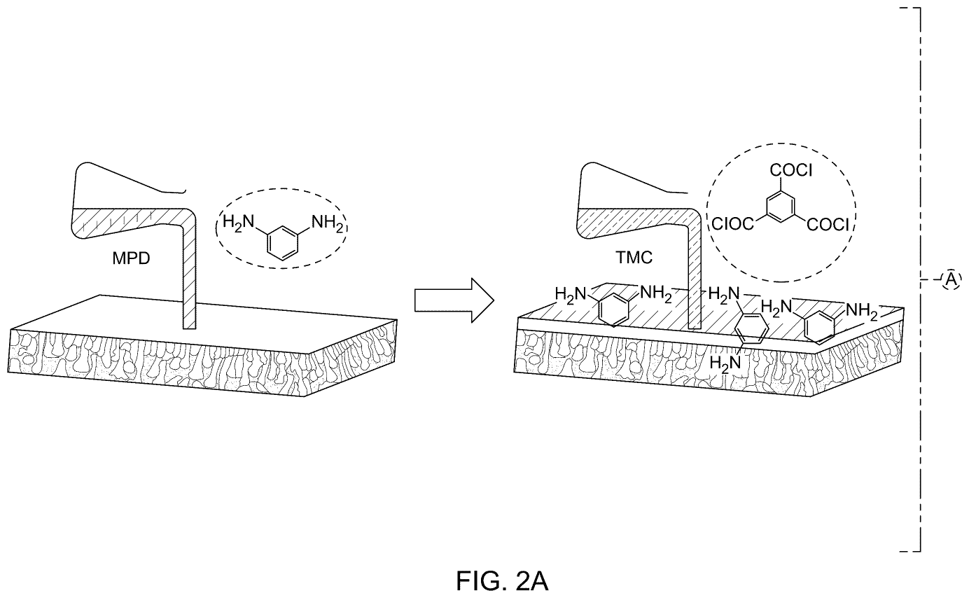

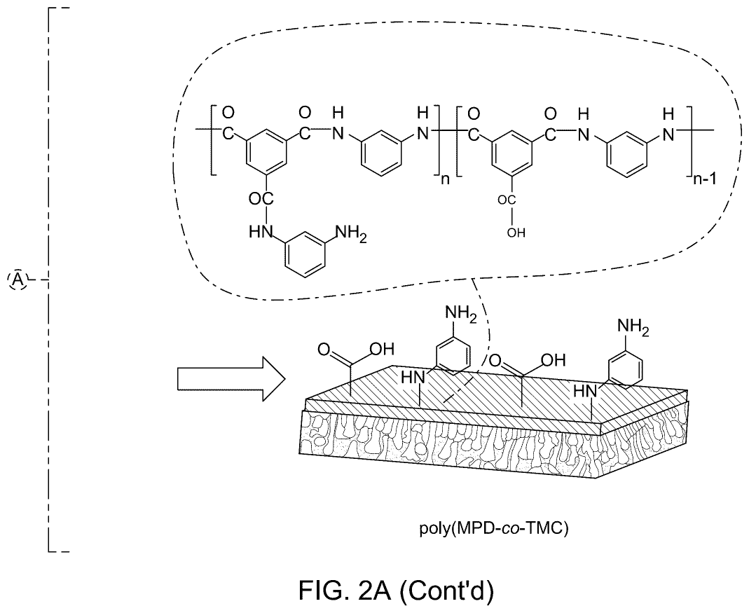

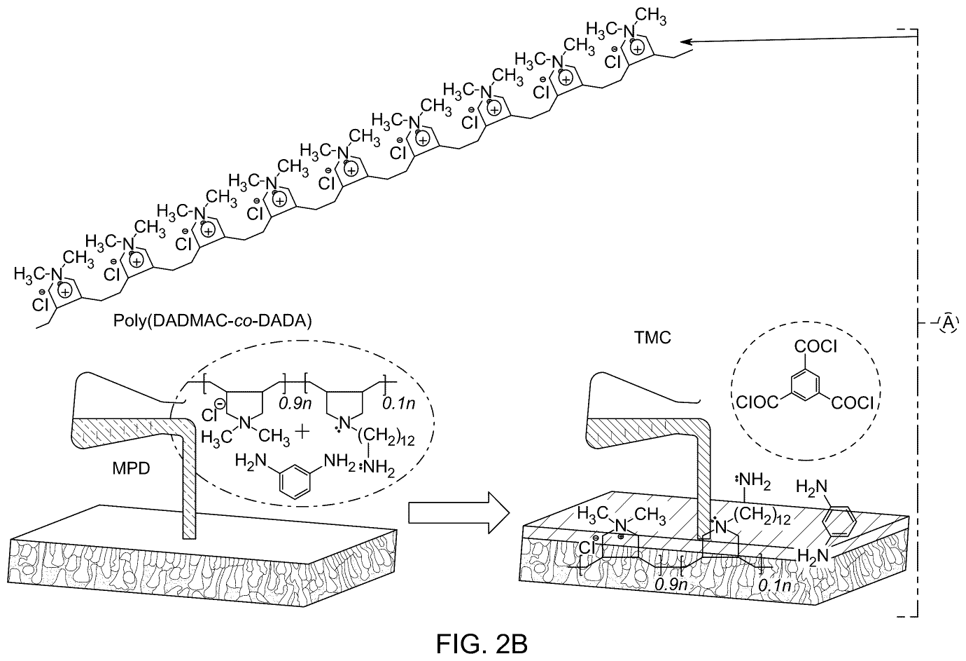

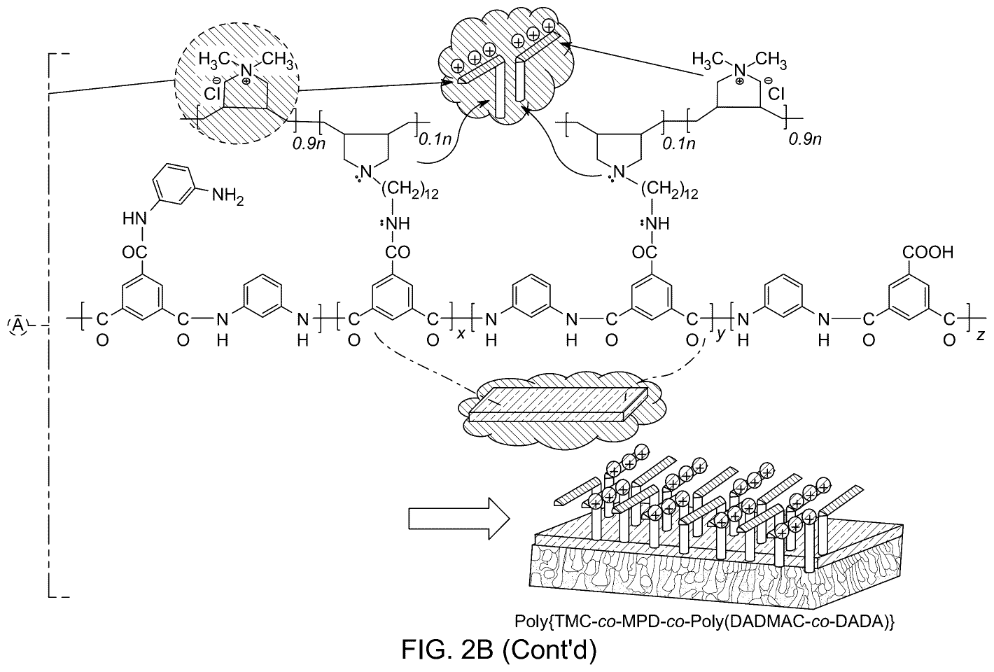

For the formation of a polyamide active layer, which consists of poly{TMC-co-MPD-co-poly(DADMAC-co-DADA)}, the relevant solution has been prepared in their respective solvents. An aqueous phase (solution-A) is prepared, which contains 2% (w/v) MPD, 3% (w/v) Triethanolamine (TEA), 0.1% (w/v) sodium dodecyl sulfate (SDS), and 0.1% (w/v) or 0.2% (w/v) poly-(DADMAC-co-DADA). The second solution of 0.2% (w/v) of TMC (solution B) was prepared in hexane. In solution A, the TEA acts as a base and helps to neutralize the HCl produced during the amine and acid chloride reaction. It also assists in the deprotonation of the MPD and improves its reaction capability. The SDS was used to enhance the interaction of the MPD with the PS support. The PS support was dipped into the aqueous solution-A for 10 min, then the PS support was removed, and the excessive solution was wiped out with the help of the rubber roller. After that, solution B was poured for 1 min, which resulted in the formation of the poly-(DADMAC-co-DADA) grafted polyamide active layer on the surface of the PS support. The membrane was removed, washed with the hexane, and placed in the oven at 50° C. for 10 min to further strengthen the polyamide layer. After that, the membranes were stored in deionized water for further examination and evaluation. The grafted membrane incorporated with 0.1% and 0.2% poly-(DADMAC-co-DADA) will be referred to as M-1 and M-2, respectively. The pristine membrane (M-0) was synthesized in a similar fashion, except the poly-(DADMAC-co-DADA) doping was absent in the aqueous solution of the diamines. The schematic illustration of the pristine and the poly-(DADMAC-co-DADA) grafted membranes can be seen in FIG. 2A and FIG. 2B, respectively.

### Example 7: Filtration

The filtration of the pristine and the poly-(DADMAC-co-DADA) grafted membranes were performed using the Sterlitech company three filtration cells crossflow setup. For all filtration testing, the membranes were cut into a size of 10 cm×5.5 cm to fit into the custom-built lab-scale crossflow setup. All the membranes were compacted for 1 hour before testing for water permeation, salt testing, and fouling study at 50 bar. The different concentrations of NaCl were evaluated, including 2000 ppm and 10000 ppm of NaCl. The TDS of the feed and the permeate were analyzed by using the Ultrameter II (Myron). All the results of the water permeation, desalination, and fouling study were conducted at a pressure of 45 bar, and the feed temperature was maintained at 23° C. using the recirculating chiller.

The permeate flux of the various membranes was calculated using the following Equation 1

$$J = V / ( A \times t ) \qquad Eq . 1$$

Where V is the volume in liters, A is the area of the membrane in m², and t is the time in hours. The salt rejections were calculated using Equation 2.

$$R ( \% ) = ( \frac{Cf - Cp}{Cf} ) \times 100 \qquad Eq . 2$$

Where Cf is the feed concentration, Cp is the concentration of the permeate.

### Example 8: Characterization

The synthesis of the next generation of the anti-fouling polymer with a permanent charge is described. These polymers are tested for membrane applications due to their interaction with the water, forming an enhanced hydration layer, high permeation flux, and anti-fouling behavior. In the present disclosure, monomer 1 named diallydimethylammonium chloride (DADMAC), and monomer 2 N¹, N¹-diallyldodecane-1,12-diammonium chloride (DADAC) underwent AMPD-initiated cyclopolymerization to afford poly(DADMAC-co-DADAC) 3 in excellent yield of 88%, as depicted in FIG. 3. Upon base treatment, 3 was transformed to poly(DADMAC-co-DADA) 4, which contains one cationic and two basic tertiary nitrogen. The schematic representation and chemical pathway of the cationic polymer synthesis are shown in FIG. 3

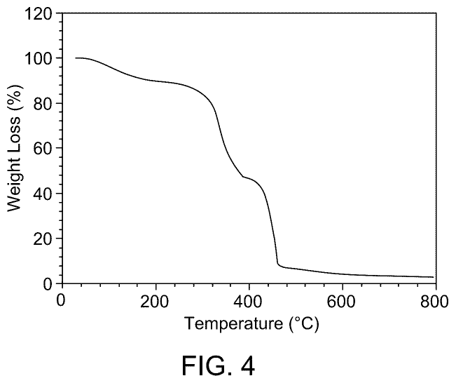

The thermal stability of the designed polymer was investigated with the help of the TGA. The TGA curve (FIG. 4) for 3 shows a weight loss of 11% up to 210° C., attributed to moisture removal. A loss of 40% was observed in the range 280-400° C., and 46% loss in the range 400-470° C. is attributed to the loss of pyrrolidine rings. Overall, the TGA analysis has shown the improved stability of the synthesized polymer, and it has remained stable up to 210° C. It has been shown that the polymer remains stable in the membrane at high temperatures.

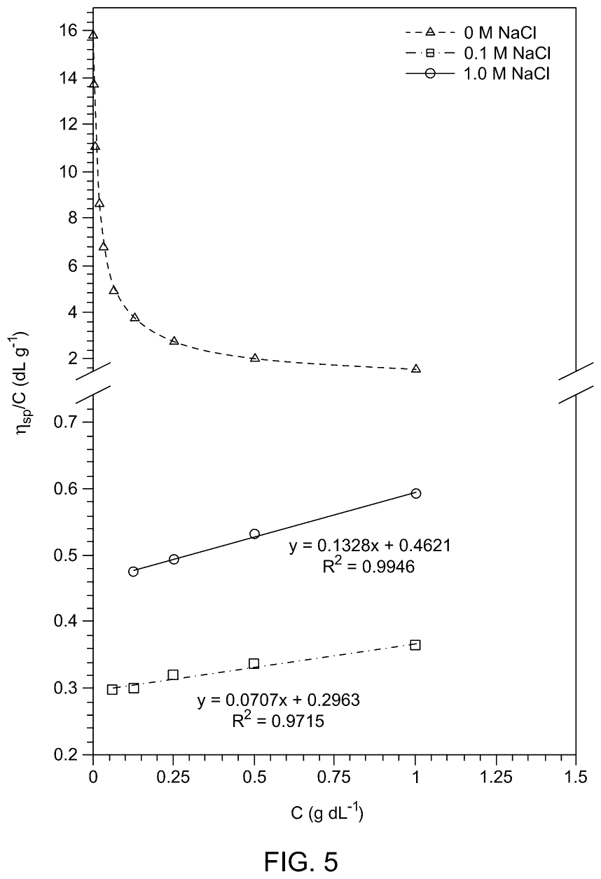

The viscosity plots of poly (DADMAC-co-DADAC) 3 in 0.1 M NaCl are shown in FIG. 5. The intrinsic viscosities in 0.1 M and 1.0 M NaCl were found to be 0.4621 and 0.2963 g dL⁻¹, respectively. In the absence of NaCl, the viscosity plot becomes concave upward, as expected of a polyelectrolyte. Viscosity average molar mass M̅ᵥ̅ was calculated using the Mark-Houwink equation:

$$[ η ] = K {{\overline{M}}_{v}}^{a}$$

where [η] value of 0.2963 dL g⁻¹ for 5, in 1 M NaCl at 30° C. Mark-Houwink parameters ‘K’ was taken as 1.12×10⁻⁴ dL g⁻¹ and ‘a’ as 0.82 (Topchiev, D. A., Malkanduev, Y. A., Yanovsky, Y. G., Oppengeim, V. D., Kabanov, V. A., 1989. Some features of dimethyl diallyl ammonium chloride high conversion polymerization in aqueous solutions. Eur Polym J 25, 1095-1098, which is incorporated herein by reference in its entirety). The M̅ᵥ̅ value is calculated to be 14920 g mol⁻¹.

The proton (¹H) and the carbon (¹³C) NMR have provided information regarding the synthesis of the poly(DADMAC-co-DADAC). The alkenes protons of the diallyl are the key points in recognizing the synthesis. The ¹H and ¹³C NMR spectra are displayed in respective FIG. 6 and FIG. 7. Alkene protons marked ‘a’ and ‘b’ in FIG. 6 (a), (b) and FIG. 7 (a), (b) disappeared after polymerization as revealed by their absence in FIG. 6 (c), (d), and FIG. 7 (c), (d).

Morphological analysis of the pristine and the membrane surface and poly(DADMAC-co-DADA) functionalized membranes were characterized thoroughly using the field emission-scanning electron microscope (FE-SEM). The SEM images of the pristine membrane (M-0), prepared by the reaction of the MPD and with TMC in the presence of the 0.1% SDS, appeared smoother at lower and higher magnifications (FIGS. 8A-8C). A significant change in surface morphology has been observed after grafting the poly(DADMAC-co-DADA) into the active layer. From the structure and the chemistry of the synthesized poly(DADMAC-co-DADA), it is known that after every nine DADMAC units, one DADA unit appears in the positively charged poly(DADMAC-co-DADA). The DADA links the positively charged polymer into the active layer as it contains the long alkyl chain terminated with the amine group. FIGS. 8D-8F, a slightly rough surface starts appearing at the scale bar of 1 μm, which is captured at the magnification of 60,000×. The granular structures become visible to some extent, and similar texture is observed throughout the surface, showing the surface's uniformity. It shows the grafting of the poly(DADMAC-co-DADA) into the active layer of the M-1 membrane. The increase in surface roughness has been observed as the poly(DADMAC-co-DADA) grafting concentration was increased in the aqueous phase. In FIGS. 8G-8I, the ridge-and-valley structures have become more prominent in the M-2 membrane. The appearance of a significant rough surface is due to the extensive grafting of the positively charged polymer, and this shows that the poly(DADMAC-co-DADA) polymer is grafted into the active layer through the amide linkage during the formation of the active polyamide layer.

Cross-sectional views of the pristine (M-0) and the poly(DADMAC-co-DADA) functionalized membranes (M-1 and M-2) can be seen in FIG. 9A to FIG. 9C, respectively. In all membrane cross-sections, the four regions can be recognized. One is the dense top layer, which is usually called the active layer and formed in pristine with the interaction of the TMC and the MPD, and in the M-1/M-2 membranes formed by the interaction of the TMC, MPD, and poly(DADMAC-co-DADA). Right after the top layer, the finger-like porous sublayer can be recognized, which opens to larger macro voids near the bottom side. The finger-like projections are the polysulfone support fabricated by the phase inversion process. These finger-like projections are formed during the diffusion of the solvent and the non-solvent (Vilakati, G. D., Wong, M. C. Y., Hoek, E. M. V., Mamba, B. B., 2014. Relating thin film composite membrane performance to support membrane morphology fabricated using lignin additive. J Memb Sci 469, 216-224, which is incorporated herein by reference in its entirety). These macro voids near the bottom end into a spongy structure. The spongy-like structure depth depends upon the diffusion rate of the solvent and the non-solvent (Baig, N., Arshad, Z., Ali, S. A., 2022a. Synthesis of a biomimetic zwitterionic pentapolymer to fabricate high-performance PVDF membranes to separate oil-in-water nano-emulsions efficiently. Scientific Reports 2022 12:1 12, 1-15, which is incorporated herein by reference in its entirety). In the end, the PET non-woven support can be observed.

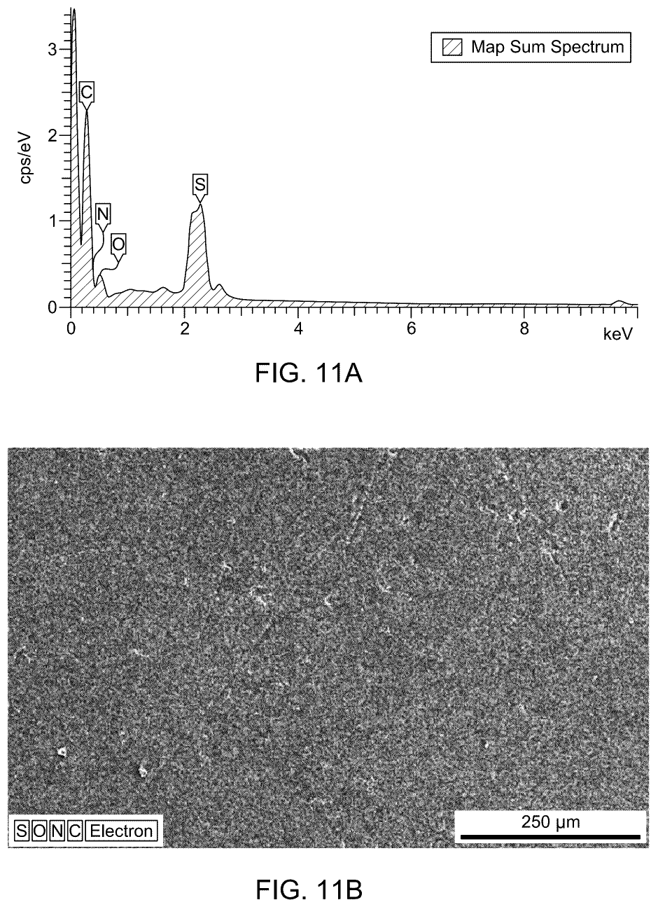

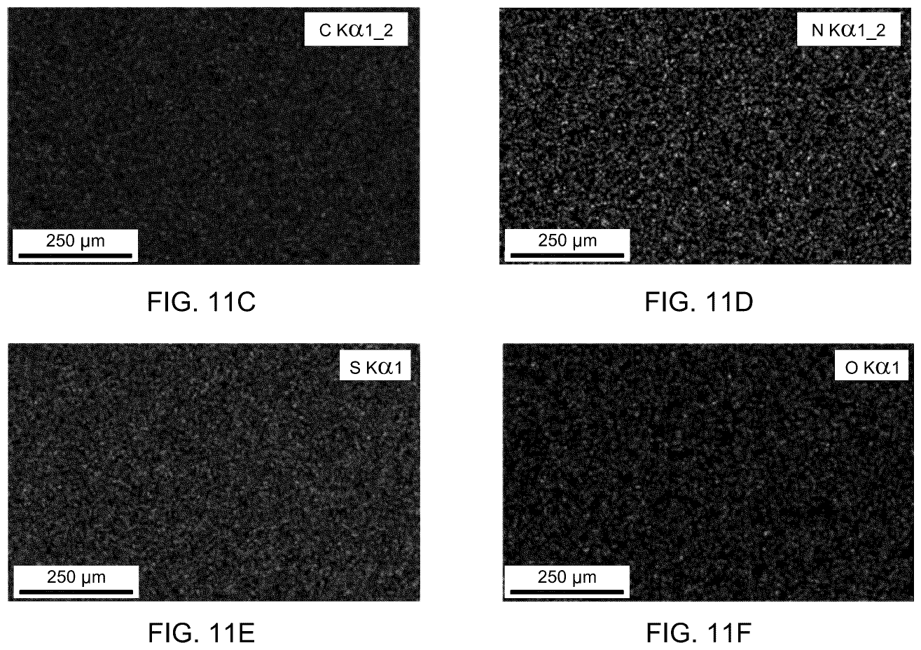

All these regions can be observed in all membranes M-0 (FIG. 9A), M-1 (FIG. 9B), and M-2 (FIG. 9C). In FIG. 9A, the active layer of the pristine and the poly(DADMAC-co-DADA) functionalized membranes can be seen (A1), whereas the FIG. 9B shows the detailed cross-section view of the membranes (B2). In FIG. 10C, through the cross-section of the active layer, the roughness can be observed (C2). It appears due to grafting as it is invisible in the cross-section of the pristine membrane (FIG. 10). The elemental mapping of the poly(DADMAC-co-DADA) functionalized membranes has shown the uniform distribution of carbon (C), nitrogen (N), oxygen (O), and sulfur (S). These were the expected elements in the membrane (FIG. 11A-FIG. 11F).

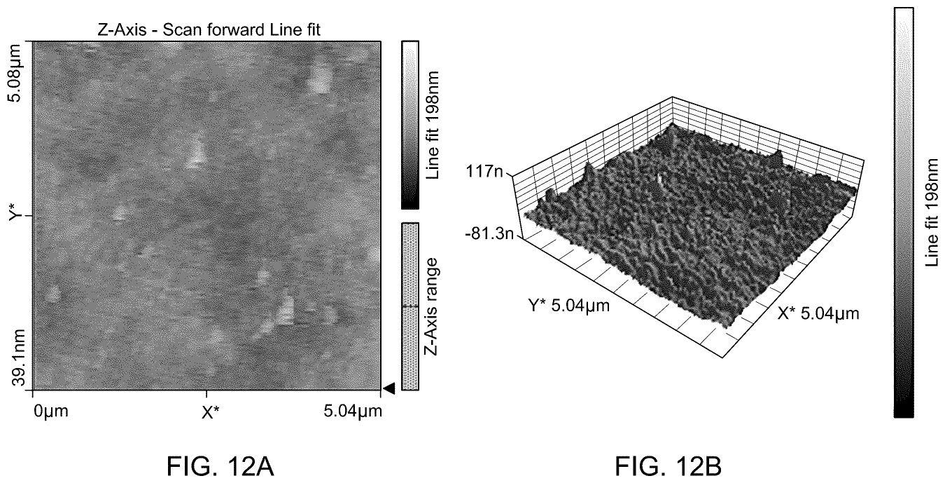

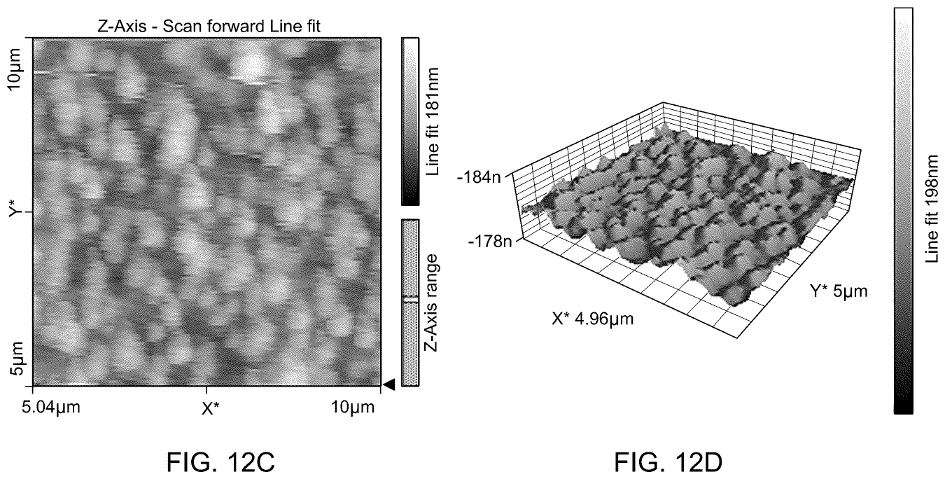

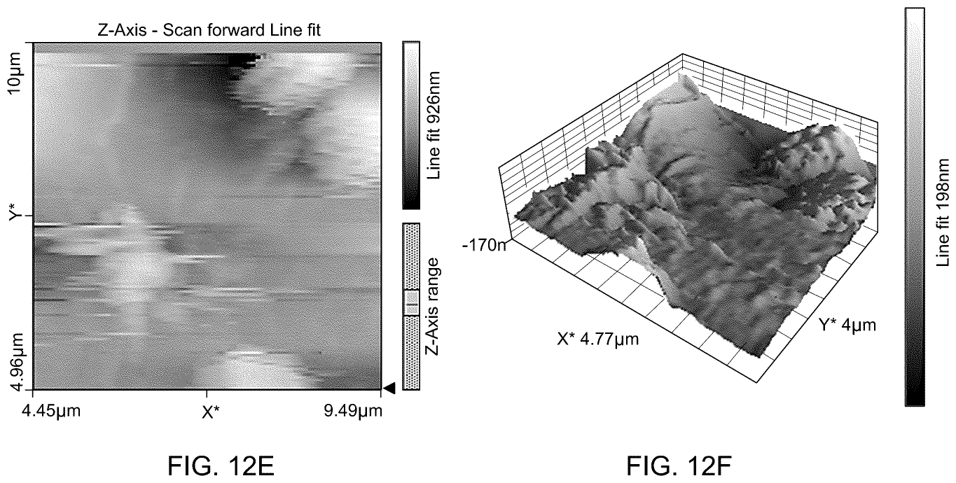

Atomic force microscopy (AFM) has provided detailed information regarding the surface changes after grafting poly(DADMAC-co-DADA). From AFM analysis of the pristine and the functionalized membranes, a clear difference in surface morphology can be observed that has also been observed in the FE-SEM analysis of the membranes. The AFM analysis has shown that the surface roughness is linked to the degree of grafting of the poly(DADMAC-co-DADA) into the active layer. The arithmetical mean height of the M-0 membrane was about 6.8 nm, showing the surface's smoothness (FIGS. 12A-12B). As the grafting polymer concentration was increased during the formation of the active layer, the roughness of the membranes was enhanced. The average surface roughness was increased to 17.3 nm when the MPD solution contained 0.1% of poly(DADMAC-co-DADA), and surface roughness was sharply increased to 89.2 nm as the concentration of the poly(DADMAC-co-DADA) increased to 0.2%. In the case of the pristine membrane, the conformal layer of polyamide is formed; however, the grafted polymer, instead of the formation of the conformal layer, the grafted poly(DADMAC-co-DADA), appeared as a separate aggregate, or more appropriately word islands in the dry state. These grafted polymer aggregates are very much visible in the 3D view of the M-1 (FIG. 12D) and M-2 membranes (FIG. 12F). The grafted polymer aggregates are smaller in the case of the M-1 membrane and become somehow more significant as the grafting polymer concentration increases. The maximum peak height observed in the case of the M-1 membrane was about 89.1 nm, which has become 409.2 nm in the M-2 membrane. Thus, the grafting of the poly(DADMAC-co-DADA) results in the formation of aggregates on the surface of the membranes. These findings are consistent with the grafted polymers in the active layer, and in the dry state of the membranes, it was present in the form of aggregates that look like islands. Poly(acrylic acid) (PAA) appeared as aggregates after grafting on the surface of the polystyrene-coated glass surface. As the concentration of the grafted polymer decreased, the density of the aggregate was reduced, and a similar trend, we observed that aggregation tendency was increased as the concentration of the grafted poly(DADMAC-co-DADA) increased. In the AFM of the M-2 membranes (FIG. 12E & FIG. 12F), the aggregates appeared bigger in size, and the maximum peak height and maximum pit height values changed compared to the pristine membrane (Table 1). The AFM data has shown that the grafted polymer is present in the form of islands on the surface of the poly(DADMAC-co-DADA) functionalized membranes.

The FTIR provided detailed information regarding the presence of the various functional groups on the surface of the pristine and poly(DADMAC-co-DADA) functionalized membranes (FIG. 13). In a pristine membrane, the active layer formed by the spontaneous reaction of the MPD and TMC has shown characteristic absorption bands, which show the formation of the amide layer. The FTIR spectra depict the —N—H stretching peaks at 3366 cm⁻¹ (Machodi, M. J., Daramola, M. O., 2019. Synthesis and performance evaluation of PES/chitosan membranes coated with polyamide for acid mine drainage treatment. Scientific Reports 2019 9:1 9, 1-14). The amide-I and amide-II absorption bands were observed at 1670 cm⁻¹ and 1542 cm⁻¹, respectively (Freger, V., Gilron, J., Belfer, S., 2002. TFC polyamide membranes modified by grafting hydrophilic polymers: an FT-IR/AFM/TEM study. J Memb Sci 209, 283-292; Shao, F., Dong, L., Dong, H., Zhang, Q., Zhao, M., Yu, L., Pang, B., Chen, Y., 2017. Graphene oxide modified polyamide reverse osmosis membranes with enhanced chlorine resistance. J Memb Sci 525, 9-17). The peaks at 1584 cm⁻¹, 1503 cm⁻¹, and 1486 cm⁻¹ correspond to the aromatic C═C bond vibrations (Sandoval-Olvera, I. G., Villafaña-López, L., Reyes-Aguilera, J. A., Ávila-Rodríguez, M., Razo-Lazcano, T. A., González-Muñoz, M. P., 2017. Surface modification of polyethersulfone membranes with goethite through self-assembly. Desalination Water Treat 65, 199-207; Tang, C. Y., Kwon, Y. N., Leckie, J. O., 2009. Effect of membrane chemistry and coating layer on physiochemical properties of thin film composite polyamide RO and NF membranes: I. FTIR and XPS characterization of polyamide and coating layer chemistry. Desalination 242, 149-167; and Shao, F., Dong, L., Dong, H., Zhang, Q., Zhao, M., Yu, L., Pang, B., Chen, Y., 2017. Graphene oxide modified polyamide reverse osmosis membranes with enhanced chlorine resistance. J Memb Sci 525, 9-17). The aromatic —C—H stretching was observed at 3035 cm⁻¹, 3067 cm⁻¹, and 3092 cm⁻¹ (Faizan, M., Alam, M. J., Afroz, Z., Rodrigues, V. H. N., Ahmad, S., 2018. Growth, structure, Hirshfeld surface and spectroscopic properties of 2-amino-4-hydroxy-6-methylpyrimidinium-2,3-pyrazinedicorboxylate single crystal. J Mol Struct 1155, 695-710). However, some apparent changes in the FTIR spectra of the poly(DADMAC-co-DADA) grafted membranes have been observed. The absorption intensity in the 3100 to 3700 cm⁻¹ was enhanced due to the poly(DADMAC-co-DADA) grafting concentration. As discussed, after every nine units of the DADMAC, one unit of the DADA is repeated; the DADA contained the amine linker, which linked during the formation of the active layer by making the amide linkage and provided the web of positive charge on the surface of the membrane. Therefore, the intensity of the —N—H stretching increased due to the poly(DADMAC-co-DADA) contribution. Another evidence is the appearance of the carbonyl stretching of the carboxylic acid functional group. An absorbance band appeared at 1722 cm⁻¹ (Deal, A. M., Vaida, V., 2022. Infrared Reflection-Absorption Spectroscopy of α-Hydroxyacids at the Water-Air Interface. J Phys Chem A 18, 12), representing the carbonyl of the carboxylic acid. The poly(DADMAC-co-DADA) grafted through the formation of the amide linkage while forming the active layer; through the structure, it is clear that one amine is available for linking after every nine units of DADMAC, but it is not provided the opportunity to TMC to link at some points properly. Thus, a few of the acid chloride of the TMC in the active layer hydrolyzed into a carboxylic acid and did not participate in forming the amide linkage. As the poly(DADMAC-co-DADA) concentration increased, the free carboxylic acid also increased due to the absorption band of the carbonyl of the carboxy functional groups.

TABLE 1
The arithmetical mean height (Sa), Root means square height
(Sq), Maximum peak height (Sp), and Maximum pit height (Sv).

| Membrane | Sa (nm) | Sq (nm) | Sp (nm) | Sv (nm) |
|---|---|---|---|---|
| M-0 | 6.8 | 9.0 | 67.1 | −31.9 |
| M-1 | 17.3 | 21.5 | 89.1 | −53.1 |
| M-2 | 89.2 | 122.3 | 409.2 | −836.6 |

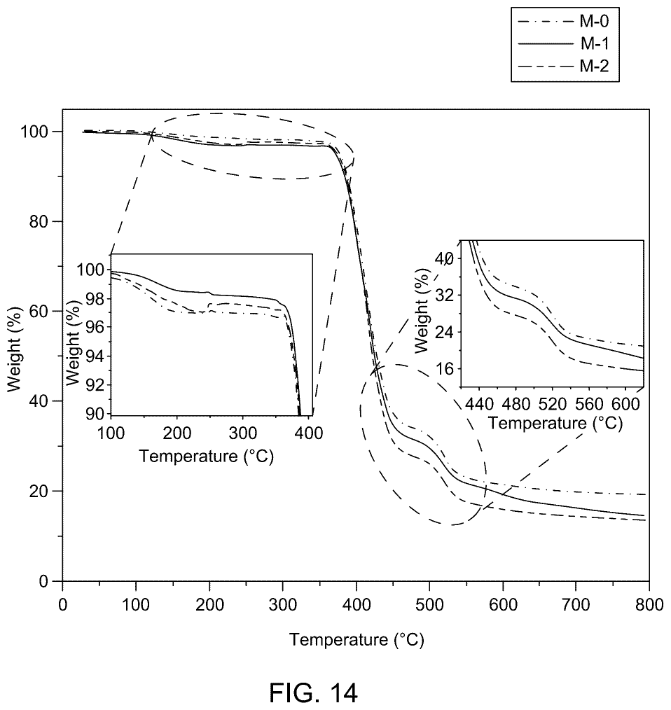

The thermogravimetric analysis (TGA) analysis was carried out in nitrogen to study the thermal behavior of the pristine and the poly(DADMAC-co-DADA) functionalized membranes. FIG. 14 illustrates the weight loss of the pristine and the poly(DADMAC-co-DADA) functionalized membranes at different temperatures from 25 to 800° C. In the M-1 and the M-2 membranes, a slight loss in weight has been observed in all membranes starting at 120° C. can be attributed to the absorbed moisture. As the temperature rises to 350° C., the weight loss has become more significant in the poly(DADMAC-co-DADA) functionalized membranes compared to the pristine membrane, which might occur due to the decomposition of the grafted poly(DADMAC-co-DADA). A sharp decline was observed around 365° C.; it continued, and at 454° C. after decomposition, the mass of M-0, M-1, and M-2 membranes was left about 36, 33.5, and 29.5%. The TGA curves have shown that mass loss increased at 454° C. as the grafted poly(DADMAC-co-DADA) concentration increased. A similar trend with the TFC RO membrane; the most loss was observed between 39° and 450° C. The grafting of the poly(DADMAC-co-DADA) during the active layer formation may affect the cross-linking of the polyamide as in the poly(DADMAC-co-DADA) after every nine units, 1 unit of monomer appears containing the free amine, which is responsible for linking of the polymer poly(DADMAC-co-DADA). However, it may affect the cross-linking of the polyamide at some points, compromising the membranes' thermal stability and resulting in more weight loss than the pristine membrane. Overall, all the pristine and positively charged polymer grafted membranes have shown thermal stability, and grafting has not significantly impacted their thermal stability.

From the morphological analysis, it has shown that the poly(DADMAC-co-DADA) grafting has changed the surface topography of the polyamide active layer (FIG. 15). It is clear that the surface wettability of the membranes is considered a critical factor in the performance of the membranes. The water contact angle on the pristine membranes was found to be about 76.8°±2.5° (FIG. 15A & FIG. 15D). The grafting of poly(DADMAC-co-DADA) into the active layer has shown a significant effect in the improvement of the hydrophilicity. The water angle reduced to 54.6°±5.9° with the grafting of 0.1% poly(DADMAC-co-DADA), as can be seen in (FIG. 15B & FIG. 15D). The surface has become water-friendly as the grafting concentration was improved to 0.2% poly(DADMAC-co-DADA), and the water contact angle was substantially reduced to 27°±3° (FIG. 15C & FIG. 15D). The water contact angle was decreased due to the presence of the positively charged chains consisting of 90% units of positively charged 1,1-dimethylpyrrolidinium motifs, which provides improved hydrophilicity to the surface that makes the surface water friendly after grafting. Hydrophilicity is a key player in improving the RO membranes' anti-fouling behavior and can help resist microbes and organic substances (Li, Q., Pan, X., Qu, Z., Zhao, X., Jin, Y., Dai, H., Yang, B., Wang, X., 2013. Understanding the dependence of contact angles of commercially RO membranes on external conditions and surface features. Desalination 309, 38-45). The RO membranes' high hydrophilicity significantly enhances the permeation flux through the membranes. A positively charged nanofiltration membranes using the UV-initiated graft polymerization of methacrylatoethyl trimethyl ammonium chloride on the PS support, thereby offering a high flux (Deng, H., Xu, Y., Chen, Q., Wei, X., Zhu, B., 2011. High flux positively charged nanofiltration membranes prepared by UV-initiated graft polymerization of methacrylatoethyl trimethyl ammonium chloride (DMC) onto polysulfone membranes. J Memb Sci 366, 363-372).

The poly(DADMAC-co-DADA) introduction into the active layer has positively impacted water permeation. FIG. 16 shows the water permeation flux of the pristine and the poly(DADMAC-co-DADA) functionalized membranes. After grafting, the water permeation flux was improved by more than 3.5 times for M-2 compared to the pristine membrane, where the active layer formed only by the interaction of the TMC and MPD. The poly(DADMAC-co-DADA) grafting in the active layer during formation has significantly enhanced the affinity towards the water, evident from the low water contact angle on the poly(DADMAC-co-DADA) grafted membranes. The pure water permeation flux of the various membrane was observed at about 16, 24.3, and 56.5 LMH, respectively. Similar trends have been observed in the permeation flux of the various membranes with the 2000 ppm feed of NaCl. As for NaCl rejection, the pristine (M-0) and the poly(DADMAC-co-DADA) grafted membranes (M-1, M-2) have shown salt rejection of 89.1±4.9%, 95.5±0.2%, and 94.7±2.3%, respectively (FIG. 17B). The small decrease in salt rejection of the M-2 compared to M-1 is due to the slight loosing of the polyamide chain at certain points due to offering a single amine group after certain intervals for covalent anchoring. In the M-2 membrane, due to the higher concertation of these points, is due to more concentration of poly (DADMAC-co-DADA), which lowers the rejection of the salt from feed. The in situ poly(DADMAC-co-DADA) grafted membranes, a high flux was observed in M-1 and M-2 membranes without compromising the salt rejections compared to the pristine membrane (FIG. 17A).

The in situ poly(DADMAC-co-DADA) grafted membranes have improved performance for the simulated brackish water desalination (10000 ppm/NaCl) (FIG. 18). For the brackish water, the M-0 membrane rejection was dropped to 81.9% with a flux of 12.8 Lm⁻²h⁻¹; however, the M-1 membranes kept the high rejection of 92.2% with a flux of 18 Lm⁻²h⁻¹. The M-2 membranes have again shown an improved high flux of 47.1 Lm⁻²h⁻¹ with an excellent rejection of 87.4%. The zwitterions grafted membranes and achieved a rejection of 86.7% with a feed concentration of 3560 ppm (Ding, J., Liang, H., Zhu, X., Xu, D., Luo, X., Wang, Z., Bai, L., 2021. Surface modification of nanofiltration membranes with zwitterions to enhance antifouling properties during brackish water treatment: A new concept of a “buffer layer.” J Memb Sci 637, 119651). However, the rejection was maintained at 87.4%, with a high flux.

The in situ grafting of the positively charged poly(DADMAC-co-DADA) into the polyamide active layer can break the trade-off and can produce the next generation of membranes, resulting in high flux membranes without compromising the rejection. In situ grafting of positively charged improved the properties of the active layer during the active layer's real-time formation, making it more effective compared to the post-treatment of the membranes. In some cases, the post-treatment may improve the anti-fouling characteristics but may compromise the flux of the membranes by adding extra layers. A linker continuously repeating in the poly(DADMAC-co-DADA) helps grafting the polymer into the active layer in real-time. It does not form an additional layer that puts any resistance to the permeation.

The grafting of poly(DADMAC-co-DADA) has enhanced the roughness, which enhanced the effective surface area and provided better permeation flux than the pristine membrane, which is substantially smooth compared to the grafted one.

The positively charged copolymer poly(DADMAC-co-DADA), after in situ grafting into the active layer, makes a strong network of positive charge on the surface of the membrane as it might be vertically anchored into the active layer, and a positive charge might be grown parallel to the surface of the active layer. It has produced a strong electrostatic repulsion between the cations, which helps achieve high rejection and, at the same time, develop a strong hydration layer. Thus, the grafting with the poly(DADMAC-co-DADA) facilitated the water molecules' fast diffusion.

All factors described above contributed to breaking the trade-off. Instead of doping, in situ grafting is applied in the design of next-generation membrane, which makes an improvement into the long-lasting trade-off of flux and rejection.

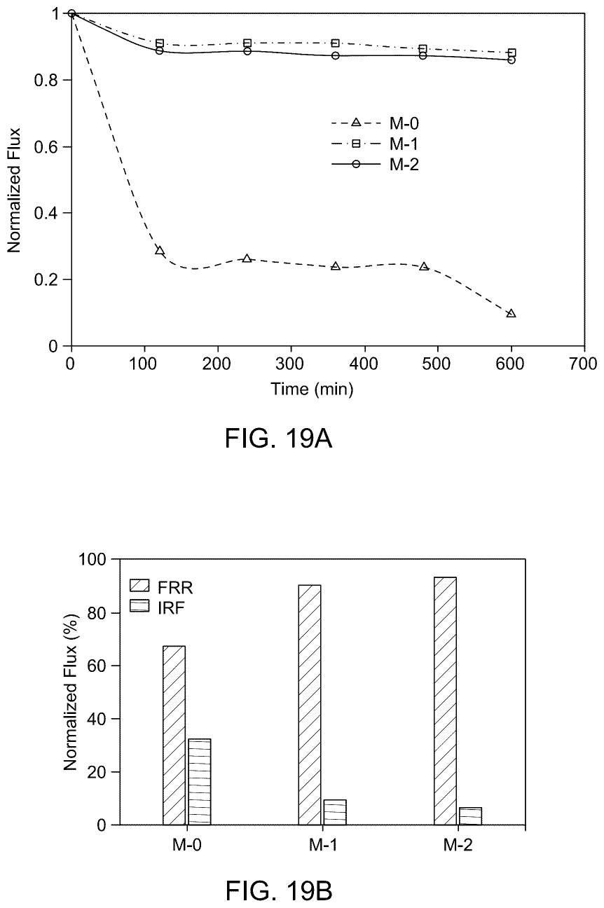

The fouling of the membranes is one of the critical factors that affect the performance of the membrane. The membrane fouling compromised the permeation flux and made the process energy intensive. Regular cleaning significantly reduced the life span of the membranes. Thus, designing any membranes with anti-fouling behavior can be a blessing for the sustainability of the desalination process. The CTAB is one of the models' positively charged foulants and has been used to investigate the performance of the pristine and the poly(DADMAC-co-DADA) functionalized membranes. The fouling study was continuously performed for 600 min using a high concentration of 2000 ppm of CTAB. The pristine and the poly(DADMAC-co-DADA) functionalized membranes behave entirely differently when exposed to the foulants. In the first 120 mins of exposure to the foulants, a sharp flux decline was observed, and the flux of the pristine membranes almost declined by 71%, whereas in the case of poly(DADMAC-co-DADA) functionalized M-1 and M-2 membranes, the flux decline was 9% and 11%, respectively. The poly(DADMAC-co-DADA) functionalized membranes kept the constant flux, and after 600 min of fouling study, the flux decline was only 11% (M-1) and 14% (M-2). After 10 hours, the pristine membrane was severely fouled, and the flux decline was more than 99% (FIG. 19A). When the pristine membranes were exposed to the positive foulants, the flux decline was about 90% after 300 minutes, and in this study, the pristine membrane exposed for a longer time of 600 minutes, the flux decline was 99%. The fouled membranes were subjected to cleaning with deionized water for 1 hour. For the pristine membrane, the flux recovery ratio to the initial flux was 67.6%, whereas the poly(DADMAC-co-DADA) functionalized membranes' flux recovery ratio was 90.6 (M-1) and 93.3% (M-2) (FIG. 19B).

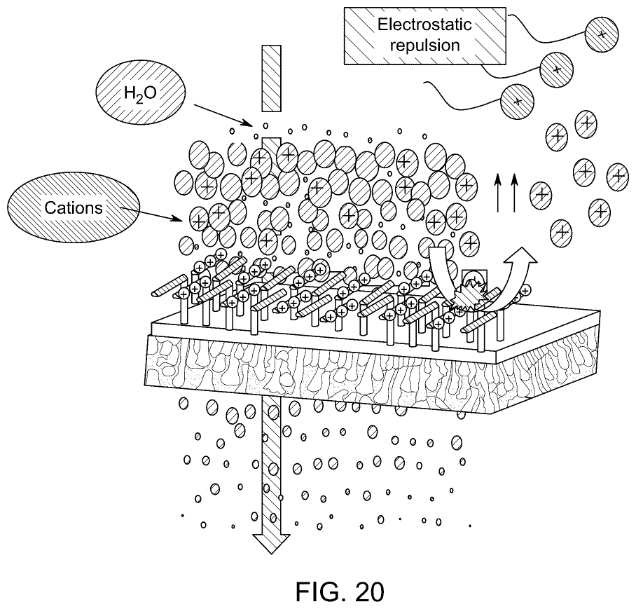

The high fouling tendency of the pristine membrane is due to the presence of negatively charged unreacted CO₂⁻ in the aromatic polyamide membrane formed by the immediate reaction of the TMC and the MPD. The CTAB is a positively charged foulants, and when it comes in contact with the pristine polyamide membrane, it is tightly adsorbed on the surface of the membrane through the positively charged end group of the CTAB. It causes a fast decline in the flux of the pristine polyamide membranes, evident from FIG. 19, and hinders its recovery. However, in the case of the poly(DADMAC-co-DADA) functionalized membranes, the surface is covered with the positively charged quaternary ammonium. Thus, the positively charged membrane strongly repels the positively charged surfactants, and only a few of them get a chance to be adsorbed on the surface, which results in a slight decline in the flux of the poly(DADMAC-co-DADA) functionalized membranes. The mechanism of the anti-fouling behavior of the poly(DADMAC-co-DADA) functionalized membranes can be seen in FIG. 20. However, the positively charged membrane might be effective for certain kinds of foulants that carried out the positive charge.

The Butler cyclopolymerization has been applied to synthesize the anti-foulant next-generation positively charged copolymer. The copolymer was rationally designed to be in-situ covalently linked during the formation of the polyamide active layer on the polysulfone support. The polymer named poly(DADMAC-co-DADA) was synthesized by controlling the composition of the diallyldimethylammonium chloride (DADMAC) and N1, N1-diallyldodecane-1,12-diammonium chloride (DADAC) in such a way that after, e.g., preferably every 9 units of DADMAC one unit of DADA repeat. The DADA is the anchoring point, whereas the DADMAC is the source of the positively charged quaternary ammonium ion. The synthesized polymer was characterized using the viscosity analysis, TGA, FTIR, proton (¹H), and the carbon (¹³C) NMR. The in-situ grafting of the poly(DADMAC-co-DADA) during the formation of the polyamide active layer increased the surface roughness, confirmed by the AFM. It is observed that the presence of hydrophobic C₁₂H₂₄ alkyl chains in the polyamide makes it compatible with the hydrophobic domains of the PS. The carboxy carbonyl peak in the FTIR spectra appeared with the increasing concentration of the poly(DADMAC-co-DADA) grafting into the polyamide layer, which indicates that some of the acyl chlorides hydrolyzed into carboxylic acid when the grafting concentration is high. The poly(DADMAC-co-DADA) polymer is rich in positively charged quaternary ammonium ions, which may impact the hydrophilicity of the membranes, and the water contact angle reduced from 76.8°±2.5° to 27°±3°. The agglomerated long chains of the grafted poly(DADMAC-co-DADA) might be relaxed when exposed to the water and produce an extensive network of the positive charge that strongly interacts with the water and creates a strong electrostatic repulsion for the cations in the saline water. Therefore, the poly-(DADMAC-co-DADA) grafted membrane (M-2) has shown a permeation flux more than 3.5 times higher than the pristine polyamide membrane while keeping the high rejection. The grafting of poly(DADMAC-co-DADA) into the active polyamide layer improved the anti-fouling behavior against the cationic foulants. The flux of the pristine polyamide membrane dropped by 99% after exposure of 10 hours to 2000 ppm CTAB, whereas the poly(DADMAC-co-DADA) grafted polyamide membrane flux dropped by less than 15%. Furthermore, the flux of the M-2 membranes quickly recovered to more than 93% after simply washing with water. However, the flux recovery of the pristine membrane was challenging due to the strong adherence of the foulants on the surface of the membranes. Thus, the poly(DADMAC-co-DADA) grafted polyamide membranes may be included in the advanced family of the next generation membrane for the treatment of saline water where the effluents contain positively charged foulants.

Numerous modifications and variations of the present disclosure are possible in light of the above teachings. It is therefore to be understood that within the scope of the appended claims, the invention may be practiced otherwise than as specifically described herein.

1: A composite membrane for desalination, comprising:
a polyethylene terephthalate (PET) nonwoven layer having a fibrous structure comprising a plurality of PET fibers;
wherein the PET nonwoven layer has an average thickness of about 30 to 200 micrometers (μm);
a polysulfone (PS) layer disposed on a surface of the PET nonwoven layer;
wherein the PS layer has an average thickness of about 30 to 100 μm;
a polyamide layer disposed on a surface of the PS layer comprising reacted units of an acyl compound, a phenylenediamine monomer, and a poly-(DADMAC-co-DADA);
wherein the poly-(DADMAC-co-DADA) has a formula (I), and n is a positive integer; and 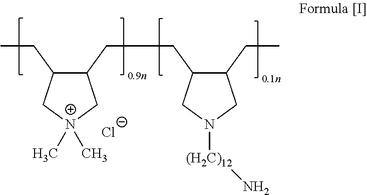
wherein the polyamide layer has a rough surface comprising a plurality of irregular-sized ridge-and-valley structures of polyamide.

2: The composite membrane of claim 1, wherein the PET nonwoven layer has an average thickness of about 50 to 100 μm.

3: The composite membrane of claim 1, wherein the PS layer has an average thickness of about 40 to 80 μm.

4: The composite membrane of claim 1, wherein:
the PS layer comprises an inner sponge sublayer adjacent to and above the PET nonwoven layer, and a finger-like porous sublayer adjacent to and below the polyamide layer;
the inner sponge sublayer comprises a plurality of macro voids having an average void size of 100 to 2000 nanometers (nm); and
the finger-like porous sublayer comprises a plurality of finger-like porous structures having an average length of 20 to 50 μm, and the plurality of finger-like porous structures are vertically aligned along a surface of the composite membrane.

5: The composite membrane of claim 1, having a water contact angle of 20 to 65°.

6: The composite membrane of claim 1, having an arithmetical mean height (Sa) of 15 to 95 nm.

7: The composite membrane of claim 1, having a root means square height (Sq) of 20 to 125 nm.

8: The composite membrane of claim 1, having a maximum peak height (Sp) of 85 to 420 nm.

9: The composite membrane of claim 1, having a maximum pit height (Sv) of −850 to −50 nm.

10: The composite membrane of claim 1, having a permeation flux of 20 and 60 L/m² hr.

11: The composite membrane of claim 1, having a salt rejection of at least 90% based on an initial weight of the salt in a salt solution.

12: A method of making the composite membrane of claim 1, comprising:
mixing monomers of diallydimethylammonium chloride (DADMAC), N¹, N¹-diallyldodecane-1,12-diammonium chloride (DADAC) in a first solvent in the presence of 2,2′-Azobis(2-methylpropionamidine) dihydrochloride (AMPD) to form a first mixture;
heating the first mixture thereby polymerizing the monomers of DADMAC and DADAC to form a poly-(DADMAC-co-DADAC) of formula (II) in a first crude mixture; 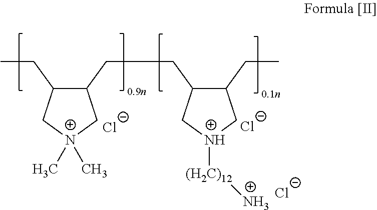
dialyzing the poly-(DADMAC-co-DADAC) in the presence of a base and drying to form the poly-(DADMAC-co-DADA);
mixing and dissolving a polysulfone (PS) polymer in a second solvent and degassing to form a PS solution;
drop casting the PS solution onto the surface of the PET nonwoven layer to form a sample containing a PS liquid layer;
immersing the sample in a liquid medium thereby precipitating the PS polymer from the PS solution to form the PS layer disposed on the surface of the PET nonwoven layer;
removing the sample from the PS solution, washing and drying;
dipping the sample after the drying in a second mixture containing the phenylenediamine monomer, and the poly-(DADMAC-co-DADA); and
contacting the sample after the dipping with a third mixture containing the acyl compound thereby polymerizing to form the polyamide layer on the surface of the PS layer.

13: The method of claim 12, wherein the base is at least one selected from the group consisting of NaOH, KOH, LiOH, and Ca(OH)₂.

14: The method of claim 12, wherein the polysulfone polymer has a weight average molecular weight (M_{w}) of 35,000 g/mol, and a number average molecular weight (Mₙ) of about 16,000 g/mol.

15: The method of claim 12, wherein the second solvent is at least one selected from the group consisting of dimethylacetamide (DMA), dimethylformamide (DMF), and dimethyl sulfoxide (DMSO).

16: The method of claim 12, wherein the PS polymer is present in the PS solution at a concentration of 5 to 40 wt. % based on a total weight of the PS solution.

17: The method of claim 12, wherein the phenylenediamine monomer is m-phenylenediamine (MPD).

18: The method of claim 12, wherein the acyl compound is trimesoyl chloride (TMC).

19: A desalination process, comprising:
passing a liquid through the composite membrane of claim 1, wherein the liquid is at least one selected from the group consisting of salty water, ocean/sea water, rejected brine, wastewater, brackish water, flowback/produced water, and waste flows.

20: The desalination process of claim 19, wherein the liquid is a salty water containing sodium chloride (NaCl), and wherein the NaCl is present in the salty water at a concentration of 1 to 20 grams per liter (g/L) based on a total volume of the salty water.
